(19) United States
(12) Patent Application Publication
(10) Pub. No.: US 2026/0361454 A1
(43) Pub. Date: Nov. 12, 2026

(54) BLOCK-CODE BASED CONSTELLATION SHAPING TECHNIQUES IN PROBABILISTIC AMPLITUDE SHAPING SYSTEMS

(71) Applicant: QUALCOMM Incorporated, San Diego, CA (US)

(72) Inventors: Wei LIU, Beijing (CN); Changlong XU, Beijing (CN); Liangming WU, Beijing (CN); Kexin XIAO, Shanghai (CN); Jian LI, Shanghai (CN); Hao XU, Beijing (CN)

(21) Appl. No.: 19/137,601

(22) PCT Filed: Feb. 23, 2023
(86) PCT No.: PCT/CN2023/077823

§ 371 Date: Jun. 10, 2025

(51) Int. Cl. H04L 1/00

(52) U.S. Cl. CPC H04L 1/0042; H04L 1/0058

(57) ABSTRACT

Methods, systems, and devices for wireless communication are described. A device may generate a set of shaping bits based on a plurality of information bit sequences, each information bit sequence of the plurality of information bit sequences being a respective stream of a demultiplexed bit sequence, where the set of shaping bits is based on a quasi-cyclic graphical code. The device may apply a bitmask sequence to a first information bit sequence of the plurality of information bit sequences to form a masked bit sequence based on the set of shaping bits and on a generator matrix, a parity-check matrix, or both, associated with the quasi-cyclic graphical code, and the device may transmit a message including the masked bit sequence.

### CROSS REFERENCE

The present Application is a 371 national phase filing of International PCT Application No. PCT/CN2023/077823 by LIU et al., entitled “BLOCK-CODE BASED CONSTELLATION SHAPING TECHNIQUES IN PROBABILISTIC AMPLITUDE SHAPING SYSTEMS,” filed Feb. 23, 2023, which is assigned to the assignee hereof, and which is expressly incorporated by reference in its entirety herein.

### FIELD OF TECHNOLOGY

The following relates to wireless communication, including block-code based constellation shaping techniques in probabilistic amplitude shaping systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support block-code based constellation shaping techniques in probabilistic amplitude shaping systems. For example, the described techniques provide for a device to generate a set of shaping bits based on multiple information bit sequences, where each information bit sequence of the multiple information bit sequences corresponds to a respective stream of a demultiplexed bit sequence. In some aspects, the set of shaping bits is based on a quasi-cyclic graphical code. Additionally, the device may apply a bitmask sequence to a first information bit sequence of the multiple information bit sequences to form a masked bit sequence based on the set of shaping bits and based on a generator matrix, a parity-check matrix, or both, associated with the quasi-cyclic graphical code. The device may transmit a message including the masked bit sequence.

An apparatus for wireless communication is described. The apparatus may include a processor, memory coupled with the processor, and instructions stored in the memory. The instructions may be executable by the processor to cause the apparatus to generate a set of shaping bits based on a set of multiple information bit sequences, each information bit sequence of the set of multiple information bit sequences including a respective stream of a demultiplexed bit sequence, where the set of shaping bits is based on a quasi-cyclic graphical code, apply a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code, and transmit a message including the masked bit sequence.

A method for wireless communication is described. The method may include generating a set of shaping bits based on a set of multiple information bit sequences, each information bit sequence of the set of multiple information bit sequences including a respective stream of a demultiplexed bit sequence, where the set of shaping bits is based on a quasi-cyclic graphical code, applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code, and transmitting a message including the masked bit sequence.

Another apparatus for wireless communication is described. The apparatus may include means for generating a set of shaping bits based on a set of multiple information bit sequences, each information bit sequence of the set of multiple information bit sequences including a respective stream of a demultiplexed bit sequence, where the set of shaping bits is based on a quasi-cyclic graphical code, means for applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code, and means for transmitting a message including the masked bit sequence.

A non-transitory computer-readable medium storing code for wireless communication is described. The code may include instructions executable by a processor to generate a set of shaping bits based on a set of multiple information bit sequences, each information bit sequence of the set of multiple information bit sequences including a respective stream of a demultiplexed bit sequence, where the set of shaping bits is based on a quasi-cyclic graphical code, apply a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code, and transmit a message including the masked bit sequence.

In some examples of the method, apparatuses, and non-transitory computer-readable medium described herein, the quasi-cyclic graphical code may be associated with a set of lifting factors for lifting a base graph having a quantity of bit nodes and generating the set of shaping bits may be based on the set of lifting factors.

Some examples of the method, apparatuses, and non-transitory computer-readable medium described herein may further include operations, features, means, or instructions for demultiplexing the bit sequence to form the set of multiple information bit sequences, each information bit sequence of the set of multiple information bit sequences having a first modulation symbol length and selecting a lifting factor from the set of lifting factors based on the first modulation symbol length and the quantity of bit nodes, where generating the set of shaping bits may be based on selecting the lifting factor.

In some examples of the method, apparatuses, and non-transitory computer-readable medium described herein, the lifting factor may be selected based on a product of the lifting factor and the quantity of bit nodes being greater than or equal to the first modulation symbol length.

Some examples of the method, apparatuses, and non-transitory computer-readable medium described herein may further include operations, features, means, or instructions for padding one or more information bit sequences of the set of multiple information bit sequences based on the selected lifting factor and the quantity of bit nodes, where generating the set of shaping bits may be based on the padding.

In some examples of the method, apparatuses, and non-transitory computer-readable medium described herein, each lifting factor of the set of lifting factors may be associated with a base generator matrix and the method, apparatuses, and non-transitory computer-readable medium may include further operations, features, means, or instructions for selecting the base generator matrix based on the selected lifting factor, where the generator matrix includes the base generator matrix and generating the set of shaping bits may be based on selecting the base generator matrix.

In some examples of the method, apparatuses, and non-transitory computer-readable medium described herein, each lifting factor of the set of lifting factors may be associated with a base parity-check matrix and the method, apparatuses, and non-transitory computer-readable medium may include further operations, features, means, or instructions for selecting the base parity-check matrix based on the selected lifting factor, where the parity-check matrix includes the base parity-check matrix and generating the set of shaping bits may be based on selecting the base parity-check matrix.

Some examples of the method, apparatuses, and non-transitory computer-readable medium described herein may further include operations, features, means, or instructions for generating the bitmask sequence based on the set of shaping bits and the generator matrix, where applying the bitmask sequence may be based on generating the bitmask sequence. In some examples of the method, apparatuses, and non-transitory computer-readable medium described herein, the quasi-cyclic graphical code may be associated with an iterative decoding process. In some examples of the method, apparatuses, and non-transitory computer-readable medium described herein, the quasi-cyclic graphical code includes a quasi-cyclic low-density generator matrix code or a quasi-cyclic low-density parity check code.

An apparatus for wireless communication is described. The apparatus may include a processor, memory coupled with the processor, and instructions stored in the memory. The instructions may be executable by the processor to cause the apparatus to generate at least two sets of shaping bits based on segmenting each of a set of multiple information bit sequences into a set of multiple segments, each information bit sequence of the set of multiple information bit sequences including a respective stream of a demultiplexed bit sequence, generate two or more bitmask sequences based on a generator matrix associated with a block code and each set of shaping bits of the at least two sets of shaping bits, apply a bitmask sequence to a first information bit sequence of the set of multiple information bit sequences to form a masked bit sequence, where the bitmask sequence includes a concatenation of the two or more bitmask sequences, and transmit a message including the masked bit sequence.

A method for wireless communication is described. The method may include generating at least two sets of shaping bits based on segmenting each of a set of multiple information bit sequences into a set of multiple segments, each information bit sequence of the set of multiple information bit sequences including a respective stream of a demultiplexed bit sequence, generating two or more bitmask sequences based on a generator matrix associated with a block code and each set of shaping bits of the at least two sets of shaping bits, applying a bitmask sequence to a first information bit sequence of the set of multiple information bit sequences to form a masked bit sequence, where the bitmask sequence includes a concatenation of the two or more bitmask sequences, and transmitting a message including the masked bit sequence.

Another apparatus for wireless communication is described. The apparatus may include means for generating at least two sets of shaping bits based on segmenting each of a set of multiple information bit sequences into a set of multiple segments, each information bit sequence of the set of multiple information bit sequences including a respective stream of a demultiplexed bit sequence, means for generating two or more bitmask sequences based on a generator matrix associated with a block code and each set of shaping bits of the at least two sets of shaping bits, means for applying a bitmask sequence to a first information bit sequence of the set of multiple information bit sequences to form a masked bit sequence, where the bitmask sequence includes a concatenation of the two or more bitmask sequences, and means for transmitting a message including the masked bit sequence.

A non-transitory computer-readable medium storing code for wireless communication is described. The code may include instructions executable by a processor to generate at least two sets of shaping bits based on segmenting each of a set of multiple information bit sequences into a set of multiple segments, each information bit sequence of the set of multiple information bit sequences including a respective stream of a demultiplexed bit sequence, generate two or more bitmask sequences based on a generator matrix associated with a block code and each set of shaping bits of the at least two sets of shaping bits, apply a bitmask sequence to a first information bit sequence of the set of multiple information bit sequences to form a masked bit sequence, where the bitmask sequence includes a concatenation of the two or more bitmask sequences, and transmit a message including the masked bit sequence.

Some examples of the method, apparatuses, and non-transitory computer-readable medium described herein may further include operations, features, means, or instructions for desegmenting the two or more bitmask sequences to form the concatenation of the two or more bitmask sequences, where applying the bitmask sequence may be based on desegmenting the two or more bitmask sequences.

Some examples of the method, apparatuses, and non-transitory computer-readable medium described herein may further include operations, features, means, or instructions for demultiplexing the bit sequence to form the set of multiple information bit sequences, each information bit sequence of the set of multiple information bit sequences having a first modulation symbol length, where the block code may be associated with a first block size, the first block size being less than the first modulation symbol length and segmenting each of the set of multiple information bit sequences into the set of multiple segments, a quantity of the set of multiple segments being based on the first modulation symbol length and the first block size, and where generating the at least two sets of shaping bits may be based on the segmenting.

Some examples of the method, apparatuses, and non-transitory computer-readable medium described herein may further include operations, features, means, or instructions for padding one or more segments of the set of multiple segments such that the quantity of the set of multiple segments includes an integer value.

Some examples of the method, apparatuses, and non-transitory computer-readable medium described herein may further include operations, features, means, or instructions for puncturing one or more segments of the set of multiple segments such that the quantity of the set of multiple segments includes an integer value.

Some examples of the method, apparatuses, and non-transitory computer-readable medium described herein may further include operations, features, means, or instructions for decoding each segment of the set of multiple segments using the block code. In some examples of the method, apparatuses, and non-transitory computer-readable medium described herein, the at least two sets of shaping bits may be generated in parallel.

An apparatus for wireless communication is described. The apparatus may include a processor, memory coupled with the processor, and instructions stored in the memory. The instructions may be executable by the processor to cause the apparatus to generate a first set of shaping bits based on a set of multiple information bit sequences, each information bit sequence of the set of multiple information bit sequences including a respective stream of a demultiplexed bit sequence, where the first set of shaping bits is based on a first block code, generate a second set of shaping bits based on the set of multiple information bit sequences, where the second set of shaping bits is based on a second block code, apply a first bitmask sequence to a first information bit sequence of the set of multiple information bit sequences to form a first masked bit sequence, where the first bitmask sequence is based on the first set of shaping bits and a first generator matrix associated with the first block code, apply a second bitmask sequence to a second information bit sequence of the set of multiple information bit sequences to form a second masked bit sequence, where the second bitmask sequence is based on the second set of shaping bits and a second generator matrix associated with the second block code, and transmit a message including the first masked bit sequence and the second masked bit sequence.

A method for wireless communication is described. The method may include generating a first set of shaping bits based on a set of multiple information bit sequences, each information bit sequence of the set of multiple information bit sequences including a respective stream of a demultiplexed bit sequence, where the first set of shaping bits is based on a first block code, generating a second set of shaping bits based on the set of multiple information bit sequences, where the second set of shaping bits is based on a second block code, applying a first bitmask sequence to a first information bit sequence of the set of multiple information bit sequences to form a first masked bit sequence, where the first bitmask sequence is based on the first set of shaping bits and a first generator matrix associated with the first block code, applying a second bitmask sequence to a second information bit sequence of the set of multiple information bit sequences to form a second masked bit sequence, where the second bitmask sequence is based on the second set of shaping bits and a second generator matrix associated with the second block code, and transmitting a message including the first masked bit sequence and the second masked bit sequence.

Another apparatus for wireless communication is described. The apparatus may include means for generating a first set of shaping bits based on a set of multiple information bit sequences, each information bit sequence of the set of multiple information bit sequences including a respective stream of a demultiplexed bit sequence, where the first set of shaping bits is based on a first block code, means for generating a second set of shaping bits based on the set of multiple information bit sequences, where the second set of shaping bits is based on a second block code, means for applying a first bitmask sequence to a first information bit sequence of the set of multiple information bit sequences to form a first masked bit sequence, where the first bitmask sequence is based on the first set of shaping bits and a first generator matrix associated with the first block code, means for applying a second bitmask sequence to a second information bit sequence of the set of multiple information bit sequences to form a second masked bit sequence, where the second bitmask sequence is based on the second set of shaping bits and a second generator matrix associated with the second block code, and means for transmitting a message including the first masked bit sequence and the second masked bit sequence.

A non-transitory computer-readable medium storing code for wireless communication is described. The code may include instructions executable by a processor to generate a first set of shaping bits based on a set of multiple information bit sequences, each information bit sequence of the set of multiple information bit sequences including a respective stream of a demultiplexed bit sequence, where the first set of shaping bits is based on a first block code, generate a second set of shaping bits based on the set of multiple information bit sequences, where the second set of shaping bits is based on a second block code, apply a first bitmask sequence to a first information bit sequence of the set of multiple information bit sequences to form a first masked bit sequence, where the first bitmask sequence is based on the first set of shaping bits and a first generator matrix associated with the first block code, apply a second bitmask sequence to a second information bit sequence of the set of multiple information bit sequences to form a second masked bit sequence, where the second bitmask sequence is based on the second set of shaping bits and a second generator matrix associated with the second block code, and transmit a message including the first masked bit sequence and the second masked bit sequence.

Some examples of the method, apparatuses, and non-transitory computer-readable medium described herein may further include operations, features, means, or instructions for selecting the first block code for generating the first set of shaping bits based on the first information bit sequence being associated with a higher transmit power than the second information bit sequence, where generating the first set of shaping bits may be based on selecting the first block code.

Some examples of the method, apparatuses, and non-transitory computer-readable medium described herein may further include operations, features, means, or instructions for selecting the second block code for generating the second set of shaping bits based on the second information bit sequence being associated with a lower transmit power than the first information bit sequence, where generating the second set of shaping bits may be based on selecting the second block code.

In some examples of the method, apparatuses, and non-transitory computer-readable medium described herein, the first block code and the second block code include block codes having different code lengths, different coding rates, or both.

Some examples of the method, apparatuses, and non-transitory computer-readable medium described herein may further include operations, features, means, or instructions for generating the first set of shaping bits and the second set of shaping bits based on segmenting each of the set of multiple information bit sequences into a set of multiple segments, where segmenting each of the set of multiple information bit sequences may be based on the first block code and the second block code including the block codes having the different code lengths.

In some examples of the method, apparatuses, and non-transitory computer-readable medium described herein, the first block code and the second block code include a same block code.

In some examples of the method, apparatuses, and non-transitory computer-readable medium described herein, the first information bit sequence includes a sequence of most significant bits associated with the message, and the second information bit sequence includes a sequence of second most significant bits associated with the message. In some examples of the method, apparatuses, and non-transitory computer-readable medium described herein, the first set of shaping bits and the second set of shaping bits may be generated in parallel.

In some examples of the method, apparatuses, and non-transitory computer-readable medium described herein, the first block code includes a first code, and the second block code includes a second code different from the first code. In some examples of the method, apparatuses, and non-transitory computer-readable medium described herein, the first code includes a polar code, and the second code includes a Hamming code.

### BRIEF DESCRIPTION OF THE DRAWINGS

FIG. 1 illustrates an example of a wireless communications system that supports block-code based constellation shaping techniques in probabilistic amplitude shaping systems in accordance with one or more aspects of the present disclosure.

FIG. 2 illustrates an example of a wireless communications system that supports block-code based constellation shaping techniques in probabilistic amplitude shaping systems in accordance with one or more aspects of the present disclosure.

FIG. 3 illustrates an example of a shaping system that supports block-code based constellation shaping techniques in probabilistic amplitude shaping systems in accordance with one or more aspects of the present disclosure.

FIG. 4 illustrates an example of a shaping system that supports block-code based constellation shaping techniques in probabilistic amplitude shaping systems in accordance with one or more aspects of the present disclosure.

FIG. 5 illustrates an example of a shaping system that supports block-code based constellation shaping techniques in probabilistic amplitude shaping systems in accordance with one or more aspects of the present disclosure.

FIG. 6 illustrates an example of a process flow that supports block-code based constellation shaping techniques in probabilistic amplitude shaping systems in accordance with one or more aspects of the present disclosure.

FIGS. 7 and 8 illustrate block diagrams of devices that support block-code based constellation shaping techniques in probabilistic amplitude shaping systems in accordance with one or more aspects of the present disclosure.

FIG. 9 illustrates a block diagram of a communications manager that supports block-code based constellation shaping techniques in probabilistic amplitude shaping systems in accordance with one or more aspects of the present disclosure.

FIG. 10 illustrates a diagram of a system including a UE that supports block-code based constellation shaping techniques in probabilistic amplitude shaping systems in accordance with one or more aspects of the present disclosure.

FIG. 11 illustrates a diagram of a system including a network entity that supports block-code based constellation shaping techniques in probabilistic amplitude shaping systems in accordance with one or more aspects of the present disclosure.

FIGS. 12 through 15 illustrate flowcharts showing methods that support block-code based constellation shaping techniques in probabilistic amplitude shaping systems in accordance with one or more aspects of the present disclosure.

### DETAILED DESCRIPTION

Some devices operating within a wireless communications system may perform bit-level encoding of a bit sequence prior to performing a transmission. In some cases, a transmit power associated with the transmission may be affected by the bit sequence to be transmitted. As such, some devices may employ shaping techniques to modify information bit sequence to reduce the transmit power. For example, a device may generate a set of shaping bits (e.g., using a shaping encoder) to mask one or more information bit sequences associated with the bit sequence (e.g., after the bit sequence is demultiplexed). The device may perform a transmission (e.g., transmit a signal) that may include the masked information bit sequence(s) and the shaping bits. A receiving device may receive a message indicating the masked information bit sequence and the shaping bits and may decode the bits to obtain the original information bit sequence (e.g., by unmasking the information bit sequence using the shaping bits). In some examples, using block codes with relatively small block code lengths to generate shaping bits and bitmask sequences may be associated with relatively lower latency and reduced complexity, which may lead to noncomplex designs for receivers at receiving devices. However, some block codes may be associated with block code lengths that are smaller than the bit sequences to be encoded, which may introduce inefficiencies at the encoding process. Further, it may be desirable to provide different protection levels for bits in different levels of an information bit sequence (e.g., encode most-significant bits with higher protection than second most-significant bits), which may involve different block codes.

In accordance with examples as described herein, a device may encode a bit sequence using one or more block codes, which may include quasi-cyclic graphical codes, by demultiplexing the bit sequence into multiple information bit sequences and encoding one or more of the information bit sequences using a quasi-cyclic graphical code. In some examples, the information bit sequences may be segmented into multiple blocks, and the shaping bits may be generated based on the multiple blocks. Then, an information bit sequence may be encoded based on the shaping bits generated according to each of the blocks of the segmented information bit sequence. In some examples, a first information bit sequence (e.g., corresponding to most significant bits of a bit sequence associated with a message) may be masked using a bitmask sequence generated based on a first block code, while a second information bit sequence (e.g., corresponding to the second most significant bits of the bit sequence associated with the message) may be masked using a bitmask sequence generated based on a second block code. In some cases, the first block code and the second block code may be the same or different. In any case, using the first and second block codes on respective information bit sequences may allow for a block code with a relatively higher correction capability but higher complexity to be used to mask bits associated with a relatively higher transmit power, while a block code with a lower complexity but a lower correction capability may be used to mask bits associated with a relatively lower transmit power.

Aspects of the disclosure are initially described in the context of wireless communications systems. Aspects of the disclosure are additionally described in the context of shaping systems and process flows. Aspects of the disclosure are further illustrated by and described with reference to apparatus diagrams, system diagrams, and flowcharts that relate to block-code based constellation shaping techniques in probabilistic amplitude shaping systems.

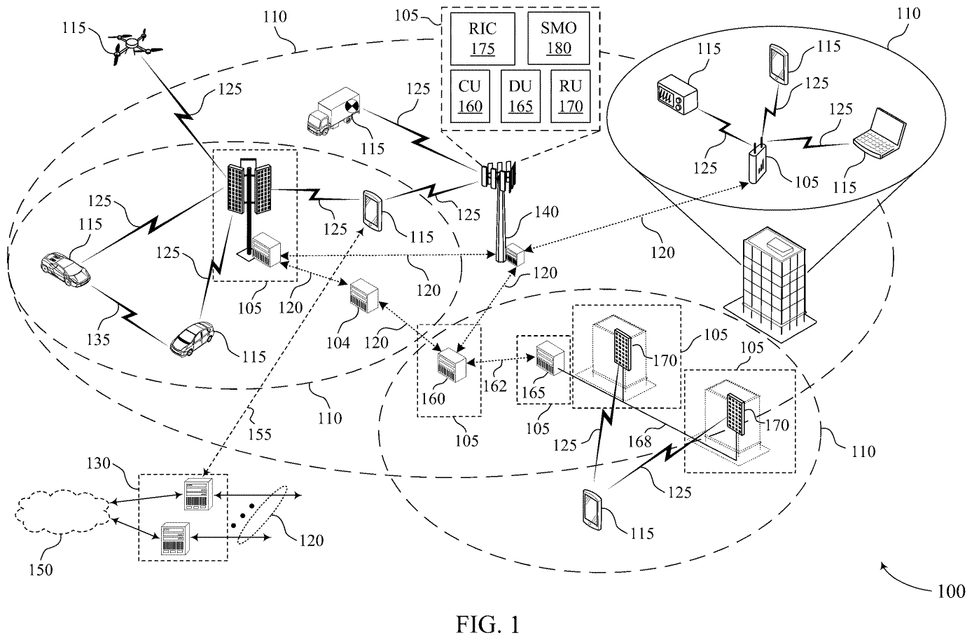

FIG. 1 illustrates an example of a wireless communications system 100 that supports block-code based constellation shaping techniques in probabilistic amplitude shaping systems in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support block-code based constellation shaping techniques in probabilistic amplitude shaping systems as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

Some devices operating within the wireless communications system 100, such as a UE 115, a network entity 105, or another device, may perform bit-level encoding of a bit sequence prior to performing a transmission. In some cases, a transmit power associated with the transmission may be affected by the bit sequence to be transmitted. As such, some devices may employ shaping techniques to modify information bit sequence to reduce the transmit power. For example, a device may generate a set of shaping bits (e.g., using a shaping encoder) to mask an information bit sequence associated with the bit sequence. The device may perform a transmission that may include the masked information bit sequence and the shaping bits. A receiving device may receive a message indicating the masked information bit sequence and the shaping bits and may decode the bits to obtain the original information bit sequence (e.g., by unmasking the information bit sequence using the shaping bits). In some examples, using block codes with relatively small block code lengths to generate shaping bits and bitmask sequences may be associated with relatively lower latency and complexity, which may lead to simple designs for receivers at receiving devices.

However, some of these block codes may be associated with block code lengths that are smaller than bit sequences to be encoded, which may introduce inefficiencies at the encoding process. Further, it may be desirable to provide different protection levels for bits in different levels of an information bit sequence (e.g., encode most-significant bits with higher protection than second most-significant bits), which may involve different block codes.

The wireless communications system 100 may support encoding of bit sequence using one or more block codes, which may include quasi-cyclic graphical codes, by demultiplexing the bit sequence into multiple information bit sequences and encoding one or more of the information bit sequences using a quasi-cyclic graphical code. In some examples, the information bit sequences may be segmented into a plurality of blocks and shaping bits may be generated based on the plurality of blocks. Then, an information bit sequence may be encoded based on the shaping bits generated according to each of the blocks of the segmented information bit sequence. In some examples, a first information bit sequence (e.g., corresponding to most significant bits of a bit sequence associated with a message) may be masked using a bitmask sequence generated based on a first block code, while a second information bit sequence (e.g., corresponding to the second most significant bits of the bit sequence associated with the message) may be masked using a bitmask sequence generated based on a second block code. This may allow for a block code with a relatively higher correction capability but higher complexity to be used to mask bits associated with a relatively higher transmit power, while a block code with a lower complexity but a lower correction capability may be used to mask bits associated with a relatively lower transmit power.

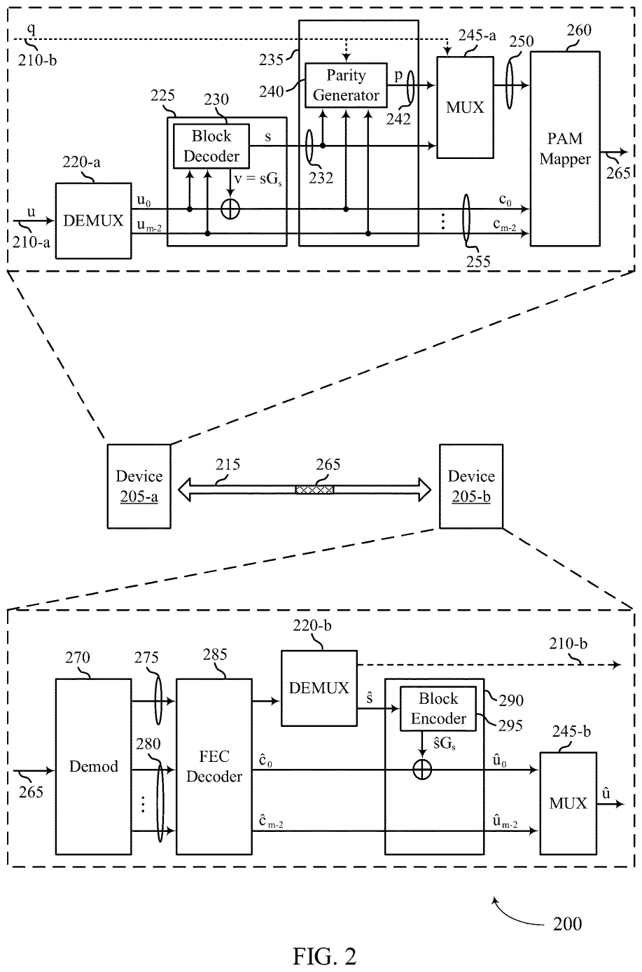

FIG. 2 illustrates an example of a wireless communications system 200 that supports block-code based constellation shaping techniques in probabilistic amplitude shaping systems in accordance with one or more aspects of the present disclosure. The wireless communications system 200 may include a device 205-a and a device 205-b, which may be examples of a UE 115, a network entity 105, or another device, as described herein with reference to FIG. 1.

In some cases, transmit power associated with wireless transmissions may be dependent on bit values and their levels. For example, the values of bits may have an effect on the transmit power, and this effect may be larger for most significant bits of a bit sequence relative to second most significant bits, which may both have larger effects relative to third most significant bits, and so on. Accordingly, the wireless communications system 200 may support techniques to perform shaping (e.g., constellation shaping) of information bits of a transmission. For example, the wireless communications system 200 may support techniques for the device 205-a to shape information bits to be transmitted in a message 265 to device 205-b via communication link 215, which may be an example of a communication link 125 as described herein, with reference to FIG. 1. By masking at least portions of the information bits, the overall transmit power may be reduced, while information for the device 205-b to reverse the masking may be included in the message 265.

The device 205-a may use a demultiplexer (e.g., DEMUX) 220-a to demultiplex a bit sequence 210-a (e.g., stream u, a binary information sequence) into multiple streams (e.g., u₀, uₘ₋₂, and, in some cases, other streams not shown, where m may correspond to a quantity of bits carried per dimension in a stream, such as an I (in-phase) or Q (quadrature) dimension for a quadrature amplitude modulation (QAM) scheme, where M=2^{m-2} for an M-ary pulse amplitude modulation (PAM). For example, the device 205-a may demultiplex stream u to obtain at least a stream u₀ corresponding to most significant bits of the bit sequence 210-a, and may obtain a stream u₁ corresponding to second most significant bits of the bit sequence 210-a.

The device 205-a may use a shaping encoder 225 to mask (e.g., encode or shape) bits corresponding to the multiple streams to obtain masked bits (e.g., shaped bits, bit sequence after a shaping operation). For example, the device 205-a may use a block decoder 230 to generate shaping bits 232 (e.g., stream s) based on the information bit sequences 255. In some cases, the block decoder 230 may compute or obtain one or more log-likelihood ratios (LLRs), and the LLRs may represent a potential power reduction that may be obtained by masking the information bit sequences 255 (e.g., a first information bit sequence of the information bit sequences 255). In some cases, the block decoder 230 may output the shaping bit sequence s, for example, to a systematic forward error correction (FEC) encoder 235. Additionally, or alternatively, the block decoder 230 may include an indication of the LLRs (e.g., within the shaping bits 232 or the information bit sequences 255).

The block decoder 230 may mask stream u₀ using a bitmask sequence v. In some examples, the bitmask sequence v may be equal to sGₛ, where s may denote the shaping bits 232, and Gₛ may be a generator matrix of a binary block code (N, K) for a wireless channel used for shaping bit sequences based on codewords of lengths N and K, respectively. In some examples, the device 205-a may also perform masking for other information bit sequences (e.g., u₁) using the block decoder 230 or other block decoders 230 not shown. In some examples, the device 205-a may generate a parity bit sequence 242 (e.g., stream p) using the systematic FEC encoder 235. The systematic FEC encoder 235 may include a parity generator 240, which may generate the parity bit sequence 242 that contains one or more parity bits based on the shaping bits 232, and the information bit sequences 255 containing the shaped information bits. In some examples, the generation of the parity bit sequence 242 using the parity generator 240 may be additionally based on an additional bit sequence 210-b (e.g., stream q). In some examples, the additional bit sequence 210-b may be utilized to enhance a spectral efficiency of the message 265 but may not convey additional information that the device 205-a is attempting to communicate to the device 205-b. In some cases, the length of the parity bit sequence 242 may be the same to a modulation symbol length associated with the parity generator 240.

The device 205-a may multiplex the parity bit sequence 242 (e.g., stream p) and the shaping bits 232 (e.g., stream s) using a multiplexer (e.g., MUX) 245-a. In some examples, the resulting bit stream 250 may represent sign bits, which may correspond to sign values of a transmission associated with the message 265. The sign bits may include shaping bits 232 (e.g., from stream s) and a parity bit sequence 242 (e.g., from stream p). The information bit sequences 255 (e.g., stream co, stream cₘ₋₂, and other streams corresponding to the shaped bits) may represent amplitude bits, which may correspond to an amplitude of the transmission associated with the message 265.

The device 205-a may map the bit stream 250 and the information bit sequences 255 using a PAM mapper 260. In some examples, the mapping may include bit-to-symbol mapping of the shaped information bit sequence 255 and the parity bit sequence 242 corresponding to the bit stream 250 and the information bit sequences 255. The PAM mapper 260 may output a message 265, which the device 205-a may transmit to the device 205-b (e.g., via communication link 215).

The device 205-b may demodulate the message 265 using a demodulator 270 (e.g., a demod block). The device 205-b may separate the message into a stream 275 corresponding to the sign bits of the message 265, and streams 280 corresponding to the amplitude bits of the message 265. In some cases, such as if LLRs were included by the block decoder 230, the demodulator 270 may additionally output the LLRs. The device may use an FEC decoder 285 to decode the stream 275 and the streams 280. For example, the FEC decoder 285 may obtain the parity bit sequence 242 included in the streams 280 and perform an FEC procedure to check for errors in the message 265. The streams 280 (e.g., stream ĉ₀, stream ĉₘ₋₂, and other streams) may correspond to shaped bits of the message 265. In some examples, the FEC decoder 285 may decode the stream 275 and the streams 280 based on the LLRs outputted by the demodulator 270.

The device 205-b may demultiplex the sign bits of stream 275 using a demultiplexer 220-b. For example, the demultiplexer 220-b may output additional bit sequence 210 -b, and shaping bits 232 ŝ associated with the shaped bits. The device 205-b may use a shaping decoder 290 to obtain the original information bits based on the shaping bits 232. For example, the shaping decoder may include a block encoder 295. The block encoder may use the shaping bits 232 ŝ and the generator matrix Gₛ to re-encode the shaped bits and obtain information bits (e.g., stream û₀, stream ûₘ₋₂, and other streams) corresponding to the original information bit sequence 255. Then, device 205-b may multiplex the one or more streams containing the original information bits (e.g., stream û₀, stream ûₘ₋₂, and other streams) using a multiplexer 245-b.

In some examples, using block codes with relatively small block code lengths at the block decoder 230 to generate the shaping bits 232 and bitmask sequences (e.g., v) may be associated with relatively lower latency and complexity, which may lead to simple designs for receivers at the device 205-b. However, some of these block codes may be associated with block code lengths that are smaller than bit sequences to be encoded, which may introduce inefficiencies at the encoding process. Further, it may be desirable to provide different protection levels for bits in different levels of an information bit sequence (e.g., encode most-significant bits with higher protection than second most-significant bits), which may involve different or more complex block codes.

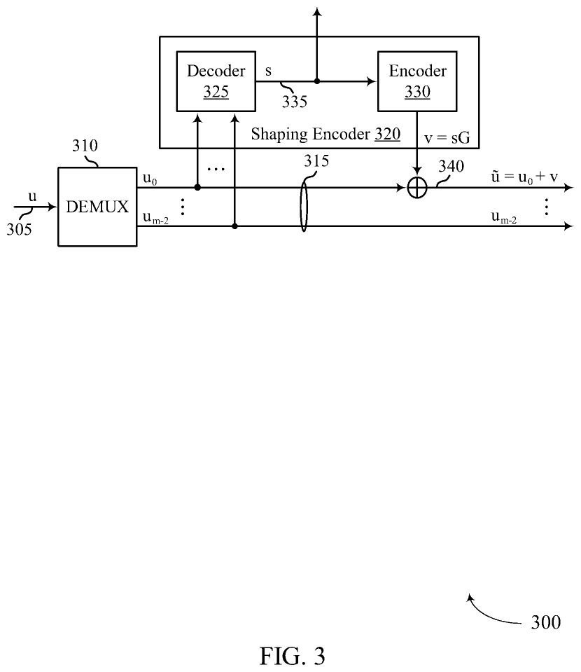

In accordance with examples as described herein, the shaping encoder 225 may encode a bit sequence using one or more block codes, which may include quasi-cyclic graphical codes. For example, the shaping encoder 225 may include one or more block decoders 230 that may use one or more different block codes, such as algebraic codes (e.g., Golay codes, Hamming codes, Bose-Chaudhuri-Hocquenghem codes, Reed-Solomon codes), graphical codes (e.g., low-density parity-check (LDPC) codes, low-density generator matrix (LDGM) codes, or a combination or compounding thereof), convolutional codes, turbo codes, or a combination of any of these codes (e.g., a dual code). In some cases, LDPC and LDGM codes may have quasi-cyclic structure, which may facilitate encoding and decoding implementations at the device 205-a and the device 205-b. Encoding using block codes using the shaping encoder 225 is discussed in more detail herein, with reference to FIG. 3.

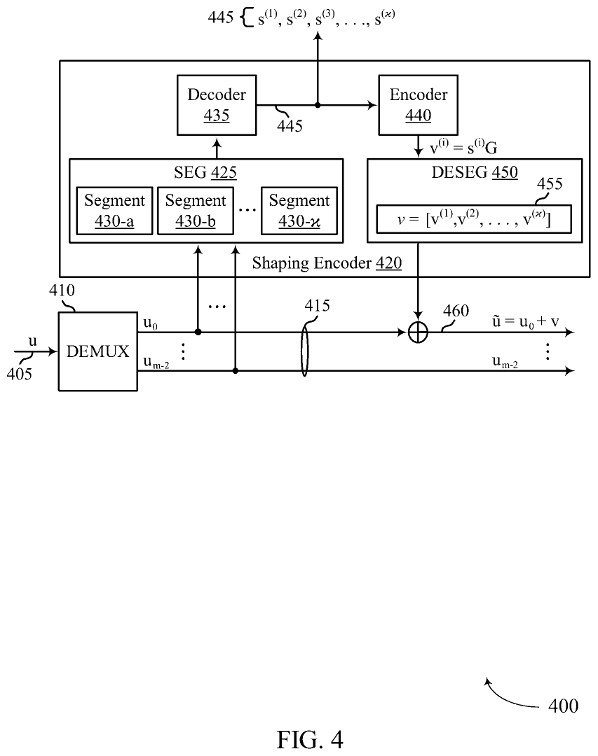

In some examples, the information bit sequences 255 may each be segmented into a plurality of blocks, and the shaping bits 232 may be generated based on the plurality of blocks obtained from the segmenting. One or more of the information bit sequences 255 may then be encoded based on the shaping bits 232 generated according to each of the blocks of the segmented information bit sequences 255. By segmenting the information bit sequences 255 into blocks, block codes with smaller block code lengths (e.g., block sizes) may be used, which may reduce complexity and improve performance associated with decoding and encoding. Encoding based on a segmentation of the information bit sequences 255 is discussed in more detail herein, with reference to FIG. 4.

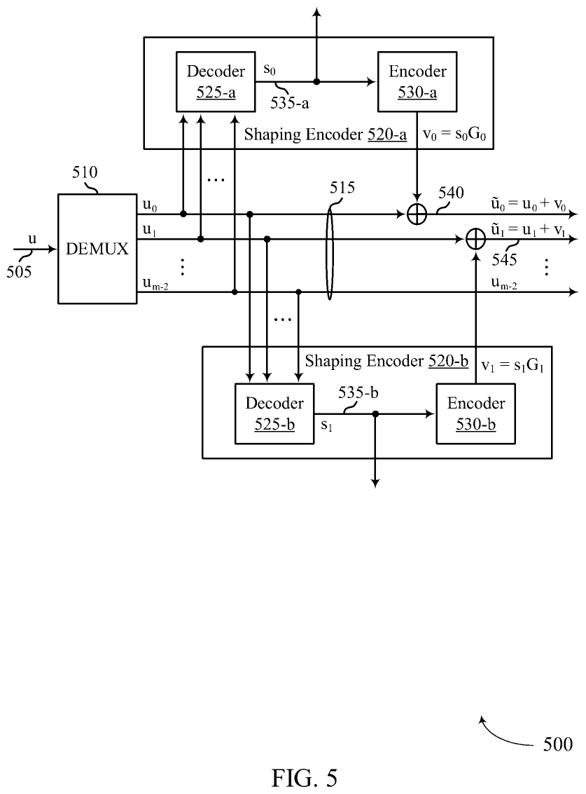

In some examples, a first information bit sequence (e.g., stream u₀) of the information bit sequences 255 may be masked using a bitmask sequence generated based on a first block code, while a second information bit sequence (e.g., stream u₁) may be masked using a bitmask sequence generated based on a second block code. Such techniques may allow for a block code with a relatively higher correction capability but higher complexity to be used to mask bits associated with a relatively higher transmit power, while a block code with a lower complexity but a lower correction capability may be used to mask bits associated with a relatively lower transmit power. In some cases, this encoding may be performed for additional information bit sequences of the information bit sequences 255. Additionally, or alternatively, the encoding may be performed using a different block decoder 230 or shaping encoder 225 for each information bit sequence of the information bit sequences 255. Encoding the information bit sequences 255 using different block codes is described in further detail herein, with reference to FIG. 5.

Accordingly, the techniques described herein provide for masking of information bit sequences 255 using multiple of block codes, which may include block codes with different block code lengths and may provide improvements in performance and correction capabilities or reduce complexity associated with encoding and decoding operations.

FIG. 3 illustrates an example of a shaping system 300 that supports block-code based constellation shaping techniques in probabilistic amplitude shaping systems in accordance with one or more aspects of the present disclosure. The shaping system 300 may be included within a transmitting device (e.g., a UE 115, a network entity 105, or another device), which may be an example the device 205-a or the device 205-b as described herein with reference to FIG. 2. Similarly, components of the shaping system 300 may be examples of corresponding components as described herein, with reference to FIG. 2. As an example, the shaping system 300 may include a shaping encoder 320, which may be an example of the shaping encoder 225 described with reference to FIG. 2.

In some examples, a bit sequence 305 (e.g., stream u, a binary information sequence) may be demultiplexed using a demultiplexer (e.g., DEMUX) 310, as described herein with reference to FIG. 2. For example, the demultiplexer 310 may output a plurality of information bit sequences 315 (e.g., streams u₀, uₘ₋₂, and, in some cases, other streams not shown) which may each have a length Nₛ (e.g., a modulation symbol length). In some cases, a first information bit sequence (e.g., stream u₀) of the information bit sequences 315 may correspond to most significant bits of the bit sequence 305, while a second information bit sequence (e.g., a stream u₁) may correspond to second most significant bits of the bit sequence 305. The information bit sequences 315 may be input into a decoder 325, which may be part of a shaping encoder 320.

The decoder 325 may generate shaping bits 335 (e.g., a shaping bit sequence s) based on the information bit sequences 315, as described herein with reference to FIG. 2. For example, the decoder 325 may generate or obtain LLR values associated with the information bit sequences 315. The LLR values may relate to a potential power savings that may be obtained by masking the information bit sequences 315 (e.g., or at least one information bit sequence thereof). The decoder 325 may output the shaping bits 335 to an encoder 330 of the shaping encoder 320 and, in some cases, to other components of a device.

The encoder 330 may generate a bitmask sequence (e.g., v, a shaping codeword) for masking (e.g., shaping) one or more of the information bit sequences 315. In some examples, the encoder 330 may utilize a quasi-cyclic graphical code, such as a quasi-cyclic LDGM or LDPC code, to generate the bitmask sequence. The quasi-cyclic graphical code may be based on a base graph lifting operation. For example, the shaping encoder 320 may be associated with a base graph containing a quantity, N, of bit nodes. In some examples, the base graph may be associated with a set of lifting factors (e.g., Z={Z₁, . . . Z_{A}}, where A is a quantity of lifting factors in the set of lifting factors) for the base graph lifting operation. Additionally, each lifting factor of the set of lifting factors may be associated with a base generator matrix (e.g., for a quasi-cyclic LDGM code) or a base parity-check matrix (e.g., for a quasi-cyclic LDPC code).

In some examples, to generate the bitmask sequence, the encoder 330 may use an iterative decoding process (e.g., a process involving one or more iterations) associated with the base graph, which may involve sum-product or min-sum procedures. The encoder 330 may select a lifting factor from the set of lifting factors based on the base graph and the length Ns of each information bit sequence 315. For example, the encoder 330 may select a lifting factor Z. from the set of lifting factors (e.g., Z) based on some criteria or threshold being met. In some examples, the selected lifting factor Z. may be selected (e.g., as the smallest lifting factor, as the largest lifting factor) such that a product of the lifting factor and the quantity of bit nodes of the base graph (e.g., Z_{c}N) is greater than or equal to the length Ns of each information bit sequence 315 (e.g., Z_{c}N≥Nₛ).

In some cases, selecting a lifting factor Z_{c} based on this criteria may result in the product of the lifting factor and the quantity of bit nodes of the base graph (e.g., Z_{c}N) being greater than the length Ns of each information bit sequence 315 (e.g., Z_{c}N>Nₛ). To generate the bitmask sequence, however, the encoder 330 may pad each information bit sequence so that the length Nₛ is equal to the product of the lifting factor and the quantity of bit nodes of the base graph (e.g., Z_{c}N). For example, the encoder 330 (e.g., or another component of the shaping system 300) may perform padding to each information bit sequence 315 by adding zero bits to (e.g., the end of) each information bit sequence 315 so that the condition Z_{c}N=Nₛ is met.

After selecting the lifting factor Z_{c}, the encoder 330 may perform a lifting operation (e.g., a lift) on the base graph to obtain (e.g., generate, select) a base generator matrix (e.g., for a quasi-cyclic LDGM code) or a base parity-check matrix (e.g., for a quasi-cyclic LDPC code). The base matrix (e.g., the base generator matrix or the base parity-check matrix) may be used by the encoder 330 to generate the bitmask sequence using the shaping bits obtained from the decoder 325. For example, the bitmask sequence may be defined as v=sG, where s corresponds to the shaping bits 335 and G corresponds to the base matrix, which may be used alongside a block code (e.g., a quasi-cyclic block code) to generate the bitmask sequence.

The encoder 330 may mask (e.g., encode or shape) an information bit sequence of the information bit sequences 315 to form masked bits (e.g., shaped bits, bit sequence after a shaping operation). For example, the encoder 330 may apply (e.g., superimpose) the bitmask sequence v to a first information bit sequence (e.g., stream u₀) of the information bit sequences 315 and form a masked information bit sequence 340 (e.g., stream u). In some examples, the encoder 330 or another component not shown may also perform masking for other information bit sequences (e.g., such as stream u₁). Accordingly, the shaping system 300 may allow for masking of information bit sequences 315 using base graph lifting to support quasi-cyclic block codes for bitmask sequence generation.

FIG. 4 illustrates an example of a shaping system 400 that supports block-code based constellation shaping techniques in probabilistic amplitude shaping systems in accordance with one or more aspects of the present disclosure. The shaping system 400 may be included within a transmitting device (e.g., a UE 115, a network entity 105, or another device), which may be an example the device 205-a or the device 205-b as described herein with reference to FIG. 2. Similarly, components of the shaping system 400 may be examples of corresponding components as described herein, with reference to FIGS. 2 and 3. For example, the shaping system 400 or aspects thereof may implement or be implemented within the shaping system 300. For instance, the shaping system 400 may include a shaping encoder 420, which may be an example of the shaping encoder 225 described with reference to FIG. 2 or the shaping encoder 320 described with reference to FIG. 3.

A bit sequence 405 (e.g., stream u, a binary information sequence) may be demultiplexed using a demultiplexer 410 (e.g., DEMUX), as described herein with reference to FIG. 2. For example, the demultiplexer 410 may output a plurality of information bit sequences 415 (e.g., streams u₀, uₘ-2, and, in some cases, other streams not shown) which may each have a length Ns (e.g., a modulation symbol length). In some cases, a first information bit sequence (e.g., stream u₀) of the information bit sequences 415 may correspond to most significant bits of the bit sequence 405, while a second information bit sequence (e.g., a stream u₁) may correspond to second most significant bits of the bit sequence 405. The information bit sequences 415 may be input into a shaping encoder 420.

In some examples, the shaping encoder 420 may include a segmentation block 425 (e.g., SEG). The segmentation block 425 may segment the one or more information bit sequences of the information bit sequences 415 into multiple segments 430, such as a segment 430-a, a segment 430-b, and a segment 430-ϰ. For example, the shaping encoder 420 (e.g., using the segmentation block 425) may segment each of the information bit sequences 415 (e.g., the stream u₀, the stream uₘ₋₂, and any other streams) into segments 430.

In some cases, the segmentation block 425 may segment the information bit sequences 415 based on a block code associated with the shaping encoder 420. For example, the shaping encoder 420 may utilize a block code to generate bitmask sequences, as described herein with reference to FIGS. 2 and 3, and the block code may be associated with a block code length N (e.g., block size). As such, the segmentation block 425 may segment the information bit sequences 415 into segments 430 having a length N (e.g., in bits), which may result in a quantity, ϰ, of segments 430 per information bit sequence of the information bit sequences 415, where x=Nₛ/N. In some cases, however, dividing the length Nₛ (e.g., the length of each information bit sequence) by the block code length N does not yield an integer value. In these cases, the segmentation block 425 may utilize zero padding or puncturing such that each segment 430 is of the block code length N (e.g., in bits) (e.g., such that an integer value of segments is achieved). For example, the segmentation block 425 may add at least one zero bit to (e.g., the end of) the one or more of the segments 430, such that each segment 430 is of the block code length N.

The segmentation block 425 may output each segment 430 to a decoder 435. The decoder 435 may generate a set of shaping bits 445 (e.g., a shaping bit sequence s, where s=s⁽ⁱ⁾=s⁽¹⁾, s⁽²⁾, s⁽³⁾, . . . , s^{(ϰ)} based on each segment 430 obtained from the segmentation block 425, as described herein with reference to FIGS. 2 and 3. For example, the decoder 435 may generate or obtain LLR values associated with the information bit sequences 415. The LLR values may relate to a potential power savings that may be obtained by masking the information bit sequences 415 (e.g., or at least one information bit sequence thereof). In some examples, the decoder 435 may contain multiple blocks that may generate shaping bits 445 for each of the segments 430 in parallel, which may speed up the generation of the shaping bits 445. That is, at least some of the segments 430 may be processed by the decoder 435 concurrently (e.g., during at least partially overlapping occasions). Additionally, or alternatively, the decoder 435 may concatenate shaping bits generated from processing each segment 430 to obtain the shaping bits 445. The decoder 435 may output the shaping bits 445 to an encoder 440 of the shaping encoder 420 and, in some cases, to other components of a device.

The encoder 440 may generate a bitmask sequence 455 (e.g., v, a shaping codeword, where v=v⁽ⁱ⁾=s⁽ⁱ⁾G based on the shaping bits 445) for masking (e.g., shaping) one or more of the information bit sequences 415. In some examples, the encoder 440 may utilize a block code to generate the bitmask sequence 455. For example, the encoder 330 may utilize a quasi-cyclic graphical code, such as a quasi-cyclic LDGM or LDPC code, to generate the bitmask sequence, as described in further detail herein with reference to FIGS. 2 and 3. The segmentation of the information bit sequences 415 may allow for the encoder 440 to utilize block codes with relatively smaller block code lengths.

In some examples, the encoder 440 may generate the bitmask sequence v⁽ⁱ⁾based on each segment 430. For example, the encoder 440 may utilize a block code with a block code length N to generate a bitmask sequence v⁽ⁱ⁾ corresponding to each of the segment 430-a, the segment 430-b, the segment 430-x, and any other segments 430. In some examples, the decoder 435 may contain multiple blocks that may bitmask sequence v⁽ⁱ⁾ for each of the segments 430 in parallel, which may speed up the generation of the bitmask sequence 455. That is, at least some of the segments 430 may be processed by the encoder 440 concurrently (e.g., during at least partially overlapping occasions). For example, the encoder 440 may generate a bitmask sequence v⁽¹⁾, a bitmask sequence v⁽²⁾, and so forth, through a bitmask sequence v^{(k)} corresponding to the segment 430-a, the segment 430-b, and so forth, through the segment 430-ϰ, respectively, and output these bitmask sequences to a desegmentation block 450. The segmentation of the information bit sequences 415 into segments 430 may support generating the bitmask sequences using exhaustive maximum likelihood decoding (e.g., maximum likelihood estimation).

The desegmentation block 450 may concatenate (e.g., desegment) each bitmask sequence obtained from the encoder 440 into the bitmask sequence 455. The shaping encoder 420 may mask (e.g., encode or shape) an information bit sequence of the information bit sequences 415 to form masked bits (e.g., shaped bits, bit sequence after a shaping operation) based on the bitmask sequence 455. For example, the shaping encoder 420 may apply (e.g., superimpose) the bitmask sequence 455 (e.g., v) to a first information bit sequence (e.g., stream u₀) of the information bit sequences 415 and form a masked information bit sequence 460 (e.g., stream û). In some examples, the shaping encoder 420 or another component not shown may perform masking for other information bit sequences (e.g., such as a stream u₁).

Accordingly, by segmenting the information bit sequences 415 into multiple segments 430, the shaping encoder 420 may utilize block codes with relatively smaller block code lengths, such as exhaustive maximum likelihood decoding. This may support utilizing block codes with relatively lower complexity, which may increase processing speed and lower complexity associated with receiver and decoder designs.

FIG. 5 illustrates an example of a shaping system 500 that supports block-code based constellation shaping techniques in probabilistic amplitude shaping systems in accordance with one or more aspects of the present disclosure. The shaping system 500 may be included within a transmitting device (e.g., a UE 115, a network entity 105, or another device), which may be an example the device 205-a or the device 205-b as described herein with reference to FIG. 2. Similarly, components of the shaping system 400 may be examples of corresponding components as described herein, with reference to FIGS. 2 through 4. For example, the shaping system 500 or aspects thereof may implement or be implemented within the shaping system 300 or the shaping system 400. In some cases, the shaping system 500 may include one or more shaping encoders 520 (e.g., shaping encoder 520-a, shaping encoder 520-b), which may be examples of the shaping encoder 225 described with reference to FIG. 2, or the shaping encoder 320 described with reference to FIG. 3, or the shaping encoder 420 described with reference to FIG. 4, or any combination thereof.

A bit sequence 505 (e.g., stream u, a binary information sequence) may be demultiplexed using a demultiplexer 510 (e.g., DEMUX), as described herein with reference to FIG. 2. For example, the demultiplexer 510 may output a plurality of information bit sequences 515 (e.g., streams u₀, u₁, uₘ₋₂, and, in some cases, other streams not shown) which may each have a length Nₛ (e.g., a modulation symbol length). In some cases, a first information bit sequence (e.g., stream u₀) of the information bit sequences 515 may correspond to most significant bits of the bit sequence 505, while a second information bit sequence (e.g., stream u₁) may correspond to second most significant bits of the bit sequence 505. The information bit sequences 515 may be input into one or more shaping encoders 520, such as a shaping encoder 520-a and a shaping encoder 520-b. While two shaping encoders 520 are shown, the shaping system 500 may support more shaping encoders (e.g., to mask a larger quantity of information bit sequences).

The shaping encoder 520-a may include a decoder 525-a and an encoder 530-a. Similarly, the shaping encoder 520-b may include a decoder 525-b and an encoder 530-b. These components may be examples of corresponding components as described herein, with reference to FIGS. 2 through 4. In some examples, the shaping encoder 520-a may be associated with masking a first information bit sequence (e.g., stream u₀), while the shaping encoder 520-b may be associated with masking a second information bit sequence (e.g., stream u₁). For example, the decoder 525-a and the decoder 525-b may generate shaping bits 535-a (e.g., a shaping bit sequence So) and shaping bits 535-b (e.g., a shaping bit sequence u₁)), respectively. In some examples, the generation of the shaping bits 535-a may be based on LLR values associated with the first information bit sequence (e.g., stream u₀), while generation of the shaping bits 535-b may be based on LLR values associated with the second information bit sequence (e.g., stream u₁).

The encoder 530-a and the encoder 530-b may generate a bitmask sequence Vo and a bitmask sequence 11, respectively. In some examples, the encoder 530-a and the encoder 530-b may utilize block codes to generate the bitmask sequences. For example, the encoder 530-a and the encoder 530-b may utilize a quasi-cyclic graphical code, such as a quasi-cyclic LDGM or LDPC code, to generate the bitmask sequence, as described in further detail herein with reference to FIGS. 2 and 3. In some cases, the encoder 530-a may utilize a first block code, while the encoder 530-b may utilize a second block code different than the first block code. This may allow for a relatively higher complexity block code to be used for generation the bitmask sequence v₀, which may be associated with a higher level of protection. Meanwhile, a relatively lower complexity block code may be used for generation the bitmask sequence v₁, which may be associated with lower decoding complexity (e.g., at a receiver).

For example, the encoder 530-a may utilize a polar code for shaping the information bit sequence u₀ and the encoder 530-b may utilize a Hamming code for shaping the information bit sequence u₁. Additionally, or alternatively, the first code and the second code may have different code lengths (e.g., block code lengths, block sizes), different coding rates, or both. In some examples, such as when block codes with relatively smaller or different block code lengths are utilized, the information bit sequences 515 may be segmented, as described herein with reference to FIG. 4.

The shaping encoder 520-a may apply the bitmask sequence vo to the first information bit sequence (e.g., stream u₀) to form a masked bit sequence 540. Similarly, the shaping encoder 520-b may apply the bitmask sequence 11 to the second information bit sequence (e.g., stream u₁) to form a masked bit sequence 545.

Accordingly, the shaping system 500 may allow for masking of multiple information bit sequences, while still allowing for an uneven level of protection across the information bit sequences. For example, a higher level of protection may be associated with the masked bit sequence 540, which may correspond to most significant bits of a transmission, while second most significant bits associated with the masked bit sequence 545 may be masked with a relatively lower complexity block code that may be associated with a lower corresponding increase in complexity at a receiver.

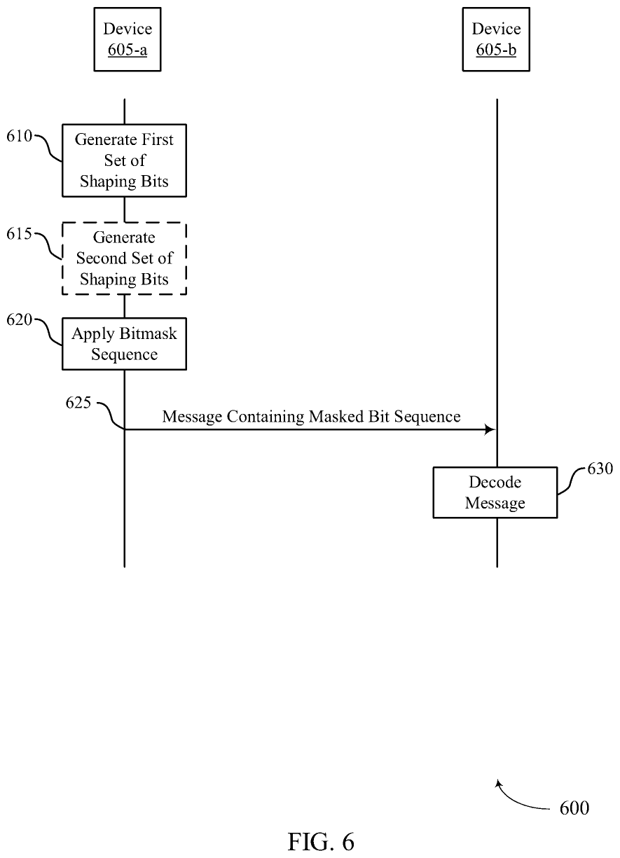

FIG. 6 illustrates an example of a process flow 600 that supports block-code based constellation shaping techniques in probabilistic amplitude shaping systems in accordance with one or more aspects of the present disclosure. The process flow 600 may include a device 605-a and a device 605-b, which may be examples of the device 205-a or the device 205-b as described herein with reference to FIG. 2.

At 610, the device 605-a may generate a first set of shaping bits. For example, the device 605-a may generate the first set of shaping bits based on information bit sequences of a demultiplexed bit sequence, as described herein with reference to FIG. 2 through 5. In some examples, the first device 605-a may generate the first set of shaping bits based on segmenting the information bit sequences into a plurality of segments, as described herein with reference to FIG. 4.

At 615, the device 605-a may generate a second set of shaping bits, as described herein with reference to FIG. 5. For example, the device 605-a may use a first decoder associated with a first block code to generate the first set of shaping bits, and a second decoder associated with a second block code to generate the second set of shaping bits.

At 620, the device 605-a may apply a bitmask sequence. For example, the device 605-a may generate a first bitmask sequence based on the first set of shaping bits and a generator matrix or a parity-check matrix associated with a first block code. The device 605-a may then apply the first bitmask sequence to a first information bit sequence of the plurality of information bit sequences to form a masked bit sequence. In some cases, the device 605-a may also generate a second bitmask sequence based on the second set of shaping bits and a generator matrix or a parity-check matrix associated with a second block code, and the device 605-a may apply the second bitmask sequence to a second information bit sequence to form a second masked bit sequence. In some examples, the first block code and the second block code may be examples of quasi-cyclic block codes associated with lifting operations for a base graph, as described herein with reference to FIG. 3.

At 625, the device 605-a may transmit a message containing the first masked bit sequence to the device 605-a. In some examples, the message may also contain the second masked bit sequence. At 630, the device 605-b may decode the message, for example, using a shaping decoder.

Accordingly, the device 605-a may support higher flexibility regarding bit masking operations, which may allow for lower complexity block codes to be used and, as such, lower complexity receivers at the device 605-b, for example. Additionally, or alternatively, the device 605-a may support bit masking operations with unequal levels of protection between information bit sequences, allowing for some information bit sequences (e.g., associated with a higher transmit power) to be masked with a first block code associated with higher protection, while other information bit sequences may be masked with other block codes associated with lower complexity.

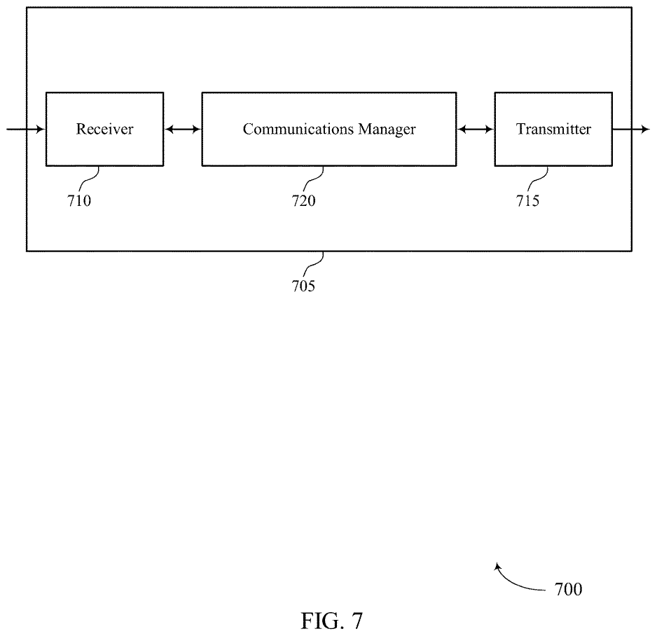

FIG. 7 illustrates a block diagram 700 of a device 705 that supports block-code based constellation shaping techniques in probabilistic amplitude shaping systems in accordance with one or more aspects of the present disclosure. The device 705 may be an example of aspects of a UE 115 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to block-code based constellation shaping techniques in probabilistic amplitude shaping systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to block-code based constellation shaping techniques in probabilistic amplitude shaping systems). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of block-code based constellation shaping techniques in probabilistic amplitude shaping systems as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 may be configured as or otherwise support a means for generating a set of shaping bits based on a set of multiple information bit sequences, each information bit sequence of the set of multiple information bit sequences including a respective stream of a demultiplexed bit sequence, where the set of shaping bits is based on a quasi-cyclic graphical code. The communications manager 720 may be configured as or otherwise support a means for applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code. The communications manager 720 may be configured as or otherwise support a means for transmitting a message including the masked bit sequence.

Additionally, or alternatively, the communications manager 720 may support wireless communication in accordance with examples as disclosed herein. For example, the communications manager 720 may be configured as or otherwise support a means for generating at least two sets of shaping bits based on segmenting each of a set of multiple information bit sequences into a set of multiple segments, each information bit sequence of the set of multiple information bit sequences including a respective stream of a demultiplexed bit sequence. The communications manager 720 may be configured as or otherwise support a means for generating two or more bitmask sequences based on a generator matrix associated with a block code and each set of shaping bits of the at least two sets of shaping bits. The communications manager 720 may be configured as or otherwise support a means for applying a bitmask sequence to a first information bit sequence of the set of multiple information bit sequences to form a masked bit sequence, where the bitmask sequence includes a concatenation of the two or more bitmask sequences. The communications manager 720 may be configured as or otherwise support a means for transmitting a message including the masked bit sequence.

Additionally, or alternatively, the communications manager 720 may support wireless communication in accordance with examples as disclosed herein. For example, the communications manager 720 may be configured as or otherwise support a means for generating a first set of shaping bits based on a set of multiple information bit sequences, each information bit sequence of the set of multiple information bit sequences including a respective stream of a demultiplexed bit sequence, where the first set of shaping bits is based on a first block code. The communications manager 720 may be configured as or otherwise support a means for generating a second set of shaping bits based on the set of multiple information bit sequences, where the second set of shaping bits is based on a second block code. The communications manager 720 may be configured as or otherwise support a means for applying a first bitmask sequence to a first information bit sequence of the set of multiple information bit sequences to form a first masked bit sequence, where the first bitmask sequence is based on the first set of shaping bits and a first generator matrix associated with the first block code. The communications manager 720 may be configured as or otherwise support a means for applying a second bitmask sequence to a second information bit sequence of the set of multiple information bit sequences to form a second masked bit sequence, where the second bitmask sequence is based on the second set of shaping bits and a second generator matrix associated with the second block code. The communications manager 720 may be configured as or otherwise support a means for transmitting a message including the first masked bit sequence and the second masked bit sequence.

By including or configuring the communications manager 720 in accordance with examples as described herein, the device 705 (e.g., a processor controlling or otherwise coupled with the receiver 710, the transmitter 715, the communications manager 720, or a combination thereof) may support techniques that allow for higher flexibility in performing masking operations by allowing for uses of a variety of block codes, such as a block code with a relatively higher correction capability but higher complexity to mask bits associated with a relatively higher transmit power, and a block code with a lower complexity but a lower correction capability to mask bits associated with a relatively lower transmit power.

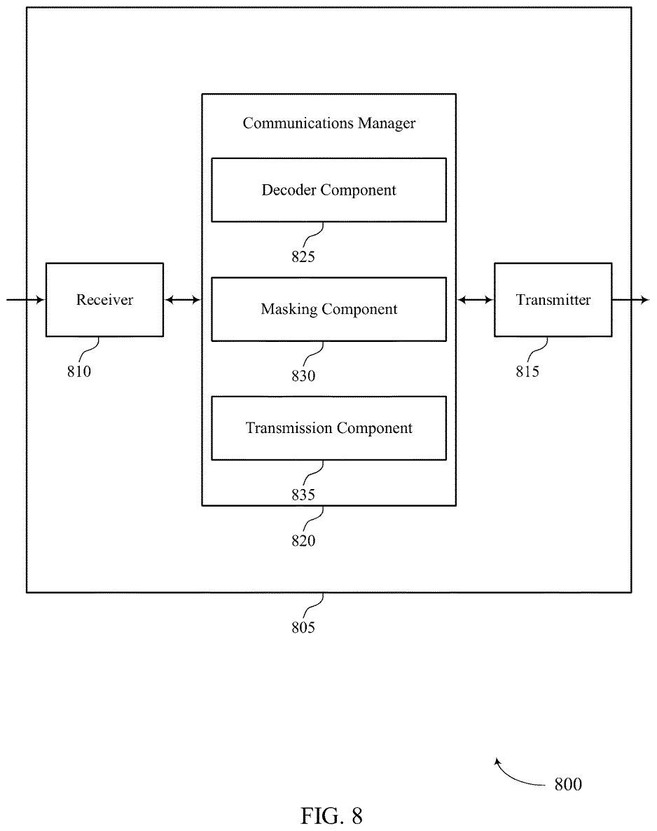

FIG. 8 illustrates a block diagram 800 of a device 805 that supports block-code based constellation shaping techniques in probabilistic amplitude shaping systems in accordance with one or more aspects of the present disclosure. The device 805 may be an example of aspects of a device 705, a UE 115, or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to block-code based constellation shaping techniques in probabilistic amplitude shaping systems). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to block-code based constellation shaping techniques in probabilistic amplitude shaping systems). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of block-code based constellation shaping techniques in probabilistic amplitude shaping systems as described herein. For example, the communications manager 820 may include a decoder component 825, a masking component 830, a transmission component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The decoder component 825 may be configured as or otherwise support a means for generating a set of shaping bits based on a set of multiple information bit sequences, each information bit sequence of the set of multiple information bit sequences including a respective stream of a demultiplexed bit sequence, where the set of shaping bits is based on a quasi-cyclic graphical code. The masking component 830 may be configured as or otherwise support a means for applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code. The transmission component 835 may be configured as or otherwise support a means for transmitting a message including the masked bit sequence.

Additionally, or alternatively, the communications manager 820 may support wireless communication in accordance with examples as disclosed herein. The decoder component 825 may be configured as or otherwise support a means for generating at least two sets of shaping bits based on segmenting each of a set of multiple information bit sequences into a set of multiple segments, each information bit sequence of the set of multiple information bit sequences including a respective stream of a demultiplexed bit sequence. The masking component 830 may be configured as or otherwise support a means for generating two or more bitmask sequences based on a generator matrix associated with a block code and each set of shaping bits of the at least two sets of shaping bits. The masking component 830 may be configured as or otherwise support a means for applying a bitmask sequence to a first information bit sequence of the set of multiple information bit sequences to form a masked bit sequence, where the bitmask sequence includes a concatenation of the two or more bitmask sequences. The transmission component 835 may be configured as or otherwise support a means for transmitting a message including the masked bit sequence.

Additionally, or alternatively, the communications manager 820 may support wireless communication in accordance with examples as disclosed herein. The decoder component 825 may be configured as or otherwise support a means for generating a first set of shaping bits based on a set of multiple information bit sequences, each information bit sequence of the set of multiple information bit sequences including a respective stream of a demultiplexed bit sequence, where the first set of shaping bits is based on a first block code. The decoder component 825 may be configured as or otherwise support a means for generating a second set of shaping bits based on the set of multiple information bit sequences, where the second set of shaping bits is based on a second block code. The masking component 830 may be configured as or otherwise support a means for applying a first bitmask sequence to a first information bit sequence of the set of multiple information bit sequences to form a first masked bit sequence, where the first bitmask sequence is based on the first set of shaping bits and a first generator matrix associated with the first block code. The masking component 830 may be configured as or otherwise support a means for applying a second bitmask sequence to a second information bit sequence of the set of multiple information bit sequences to form a second masked bit sequence, where the second bitmask sequence is based on the second set of shaping bits and a second generator matrix associated with the second block code. The transmission component 835 may be configured as or otherwise support a means for transmitting a message including the first masked bit sequence and the second masked bit sequence.

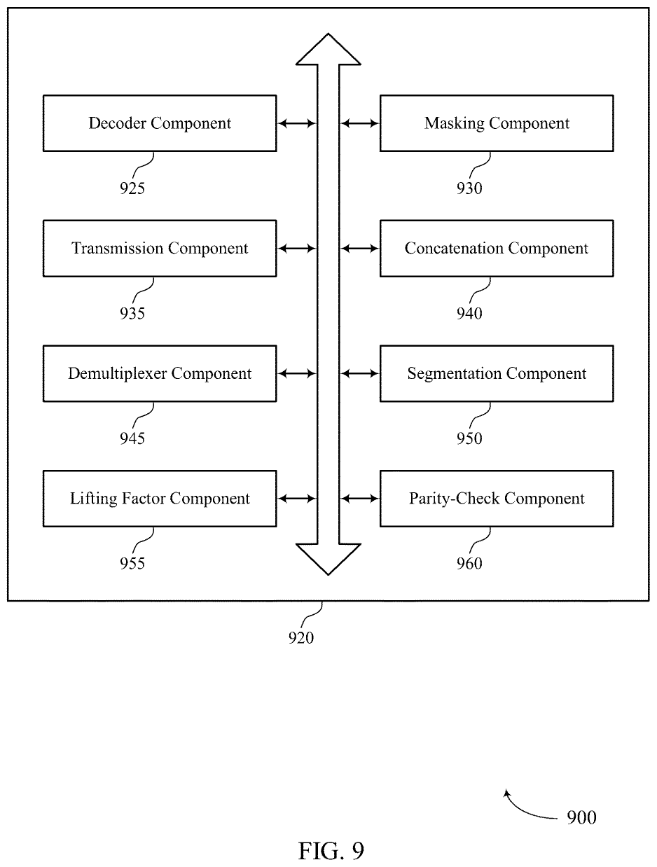

FIG. 9 illustrates a block diagram 900 of a communications manager 920 that supports block-code based constellation shaping techniques in probabilistic amplitude shaping systems in accordance with one or more aspects of the present disclosure. The communications manager 920 may be an example of aspects of a communications manager 720, a communications manager 820, or both, as described herein. The communications manager 920, or various components thereof, may be an example of means for performing various aspects of block-code based constellation shaping techniques in probabilistic amplitude shaping systems as described herein. For example, the communications manager 920 may include a decoder component 925, a masking component 930, a transmission component 935, a concatenation component 940, a demultiplexer component 945, a segmentation component 950, a lifting factor component 955, a parity-check component 960, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communication in accordance with examples as disclosed herein. The decoder component 925 may be configured as or otherwise support a means for generating a set of shaping bits based on a set of multiple information bit sequences, each information bit sequence of the set of multiple information bit sequences including a respective stream of a demultiplexed bit sequence, where the set of shaping bits is based on a quasi-cyclic graphical code. The masking component 930 may be configured as or otherwise support a means for applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code. The transmission component 935 may be configured as or otherwise support a means for transmitting a message including the masked bit sequence.

In some examples, the quasi-cyclic graphical code is associated with a set of lifting factors for lifting a base graph having a quantity of bit nodes. In some examples, generating the set of shaping bits is based on the set of lifting factors.

In some examples, the demultiplexer component 945 may be configured as or otherwise support a means for demultiplexing the bit sequence to form the set of multiple information bit sequences, each information bit sequence of the set of multiple information bit sequences having a first modulation symbol length. In some examples, the lifting factor component 955 may be configured as or otherwise support a means for selecting a lifting factor from the set of lifting factors based on the first modulation symbol length and the quantity of bit nodes, where generating the set of shaping bits is based on selecting the lifting factor.

In some examples, the lifting factor is selected based on a product of the lifting factor and the quantity of bit nodes being greater than or equal to the first modulation symbol length.

In some examples, the decoder component 925 may be configured as or otherwise support a means for padding one or more information bit sequences of the set of multiple information bit sequences based on the selected lifting factor and the quantity of bit nodes, where generating the set of shaping bits is based on the padding.

In some examples, each lifting factor of the set of lifting factors is associated with a base generator matrix, and the lifting factor component 955 may be configured as or otherwise support a means for selecting the base generator matrix based on the selected lifting factor, where the generator matrix includes the base generator matrix and generating the set of shaping bits is based on selecting the base generator matrix.

In some examples, each lifting factor of the set of lifting factors is associated with a base parity-check matrix, and the parity-check component 960 may be configured as or otherwise support a means for selecting the base parity-check matrix based on the selected lifting factor, where the parity-check matrix includes the base parity-check matrix and generating the set of shaping bits is based on selecting the base parity-check matrix.

In some examples, the masking component 930 may be configured as or otherwise support a means for generating the bitmask sequence based on the set of shaping bits and the generator matrix, where applying the bitmask sequence is based on generating the bitmask sequence.

In some examples, the quasi-cyclic graphical code is associated with an iterative decoding process. In some examples, the quasi-cyclic graphical code includes a quasi-cyclic low-density generator matrix code or a quasi-cyclic low-density parity check code.

Additionally, or alternatively, the communications manager 920 may support wireless communication in accordance with examples as disclosed herein. In some examples, the decoder component 925 may be configured as or otherwise support a means for generating at least two sets of shaping bits based on segmenting each of a set of multiple information bit sequences into a set of multiple segments, each information bit sequence of the set of multiple information bit sequences including a respective stream of a demultiplexed bit sequence. In some examples, the masking component 930 may be configured as or otherwise support a means for generating two or more bitmask sequences based on a generator matrix associated with a block code and each set of shaping bits of the at least two sets of shaping bits. In some examples, the masking component 930 may be configured as or otherwise support a means for applying a bitmask sequence to a first information bit sequence of the set of multiple information bit sequences to form a masked bit sequence, where the bitmask sequence includes a concatenation of the two or more bitmask sequences. In some examples, the transmission component 935 may be configured as or otherwise support a means for transmitting a message including the masked bit sequence.

In some examples, the concatenation component 940 may be configured as or otherwise support a means for desegmenting the two or more bitmask sequences to form the concatenation of the two or more bitmask sequences, where applying the bitmask sequence is based on desegmenting the two or more bitmask sequences.

In some examples, the demultiplexer component 945 may be configured as or otherwise support a means for demultiplexing the bit sequence to form the set of multiple information bit sequences, each information bit sequence of the set of multiple information bit sequences having a first modulation symbol length, where the block code is associated with a first block size, the first block size being less than the first modulation symbol length. In some examples, the segmentation component 950 may be configured as or otherwise support a means for segmenting each of the set of multiple information bit sequences into the set of multiple segments, a quantity of the set of multiple segments being based on the first modulation symbol length and the first block size, and where generating the at least two sets of shaping bits is based on the segmenting.

In some examples, the decoder component 925 may be configured as or otherwise support a means for padding one or more segments of the set of multiple segments such that the quantity of the set of multiple segments includes an integer value.

In some examples, the decoder component 925 may be configured as or otherwise support a means for puncturing one or more segments of the set of multiple segments such that the quantity of the set of multiple segments includes an integer value. In some examples, the decoder component 925 may be configured as or otherwise support a means for decoding each segment of the set of multiple segments using the block code. In some examples, the at least two sets of shaping bits are generated in parallel.

Additionally, or alternatively, the communications manager 920 may support wireless communication in accordance with examples as disclosed herein. In some examples, the decoder component 925 may be configured as or otherwise support a means for generating a first set of shaping bits based on a set of multiple information bit sequences, each information bit sequence of the set of multiple information bit sequences including a respective stream of a demultiplexed bit sequence, where the first set of shaping bits is based on a first block code. In some examples, the decoder component 925 may be configured as or otherwise support a means for generating a second set of shaping bits based on the set of multiple information bit sequences, where the second set of shaping bits is based on a second block code. In some examples, the masking component 930 may be configured as or otherwise support a means for applying a first bitmask sequence to a first information bit sequence of the set of multiple information bit sequences to form a first masked bit sequence, where the first bitmask sequence is based on the first set of shaping bits and a first generator matrix associated with the first block code. In some examples, the masking component 930 may be configured as or otherwise support a means for applying a second bitmask sequence to a second information bit sequence of the set of multiple information bit sequences to form a second masked bit sequence, where the second bitmask sequence is based on the second set of shaping bits and a second generator matrix associated with the second block code. In some examples, the transmission component 935 may be configured as or otherwise support a means for transmitting a message including the first masked bit sequence and the second masked bit sequence.

In some examples, the decoder component 925 may be configured as or otherwise support a means for selecting the first block code for generating the first set of shaping bits based on the first information bit sequence being associated with a higher transmit power than the second information bit sequence, where generating the first set of shaping bits is based on selecting the first block code.

In some examples, the decoder component 925 may be configured as or otherwise support a means for selecting the second block code for generating the second set of shaping bits based on the second information bit sequence being associated with a lower transmit power than the first information bit sequence, where generating the second set of shaping bits is based on selecting the second block code. In some examples, the first block code and the second block code include block codes having different code lengths, different coding rates, or both.

In some examples, the segmentation component 950 may be configured as or otherwise support a means for generating the first set of shaping bits and the second set of shaping bits based on segmenting each of the set of multiple information bit sequences into a set of multiple segments, where segmenting each of the set of multiple information bit sequences is based on the first block code and the second block code including the block codes having the different code lengths.

In some examples, the first information bit sequence includes a sequence of most significant bits associated with the message, and the second information bit sequence includes a sequence of second most significant bits associated with the message. In some examples, the first set of shaping bits and the second set of shaping bits are generated in parallel.

In some examples, the first block code and the second block code include a same block code. In some examples, the first block code includes a first code, and the second block code includes a second code different from the first code. In some examples, the first code includes a polar code, and the second code includes a Hamming code.

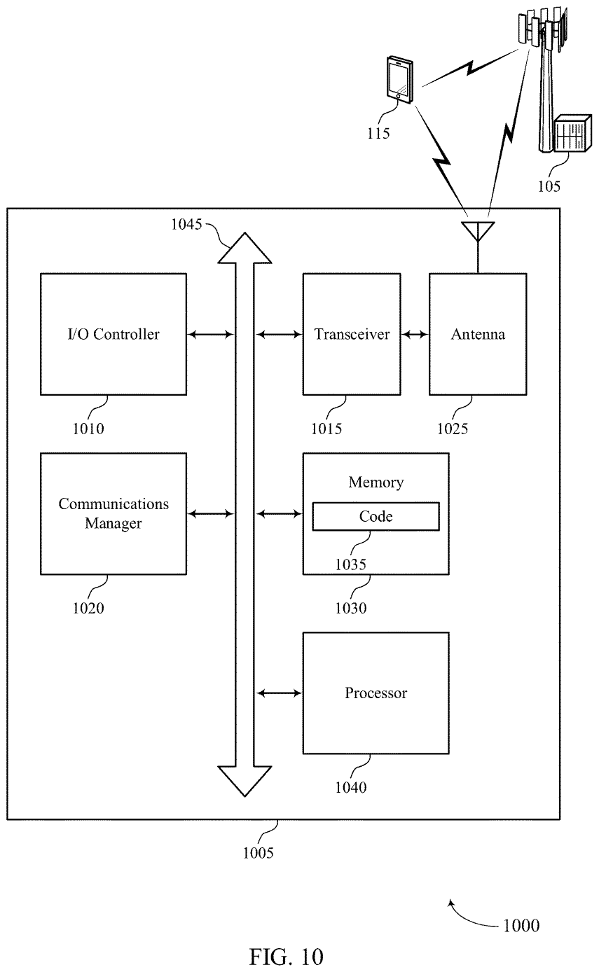

FIG. 10 illustrates a diagram of a system 1000 including a device 1005 that supports block-code based constellation shaping techniques in probabilistic amplitude shaping systems in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions.

The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting block-code based constellation shaping techniques in probabilistic amplitude shaping systems). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication in accordance with examples as disclosed herein. For example, the communications manager 1020 may be configured as or otherwise support a means for generating a set of shaping bits based on a set of multiple information bit sequences, each information bit sequence of the set of multiple information bit sequences including a respective stream of a demultiplexed bit sequence, where the set of shaping bits is based on a quasi-cyclic graphical code. The communications manager 1020 may be configured as or otherwise support a means for applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code. The communications manager 1020 may be configured as or otherwise support a means for transmitting a message including the masked bit sequence.

Additionally, or alternatively, the communications manager 1020 may support wireless communication in accordance with examples as disclosed herein. For example, the communications manager 1020 may be configured as or otherwise support a means for generating at least two sets of shaping bits based on segmenting each of a set of multiple information bit sequences into a set of multiple segments, each information bit sequence of the set of multiple information bit sequences including a respective stream of a demultiplexed bit sequence. The communications manager 1020 may be configured as or otherwise support a means for generating two or more bitmask sequences based on a generator matrix associated with a block code and each set of shaping bits of the at least two sets of shaping bits. The communications manager 1020 may be configured as or otherwise support a means for applying a bitmask sequence to a first information bit sequence of the set of multiple information bit sequences to form a masked bit sequence, where the bitmask sequence includes a concatenation of the two or more bitmask sequences. The communications manager 1020 may be configured as or otherwise support a means for transmitting a message including the masked bit sequence.

Additionally, or alternatively, the communications manager 1020 may support wireless communication in accordance with examples as disclosed herein. For example, the communications manager 1020 may be configured as or otherwise support a means for generating a first set of shaping bits based on a set of multiple information bit sequences, each information bit sequence of the set of multiple information bit sequences including a respective stream of a demultiplexed bit sequence, where the first set of shaping bits is based on a first block code. The communications manager 1020 may be configured as or otherwise support a means for generating a second set of shaping bits based on the set of multiple information bit sequences, where the second set of shaping bits is based on a second block code. The communications manager 1020 may be configured as or otherwise support a means for applying a first bitmask sequence to a first information bit sequence of the set of multiple information bit sequences to form a first masked bit sequence, where the first bitmask sequence is based on the first set of shaping bits and a first generator matrix associated with the first block code. The communications manager 1020 may be configured as or otherwise support a means for applying a second bitmask sequence to a second information bit sequence of the set of multiple information bit sequences to form a second masked bit sequence, where the second bitmask sequence is based on the second set of shaping bits and a second generator matrix associated with the second block code. The communications manager 1020 may be configured as or otherwise support a means for transmitting a message including the first masked bit sequence and the second masked bit sequence.

By including or configuring the communications manager 1020 in accordance with examples as described herein, the device 1005 may support techniques for higher flexibility in bit mapping operations, which may reduce complexity at a receiver resulting in reduced latency and longer battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of block-code based constellation shaping techniques in probabilistic amplitude shaping systems as described herein, or the processor 1040 and the memory 1030 may be otherwise configured to perform or support such operations.

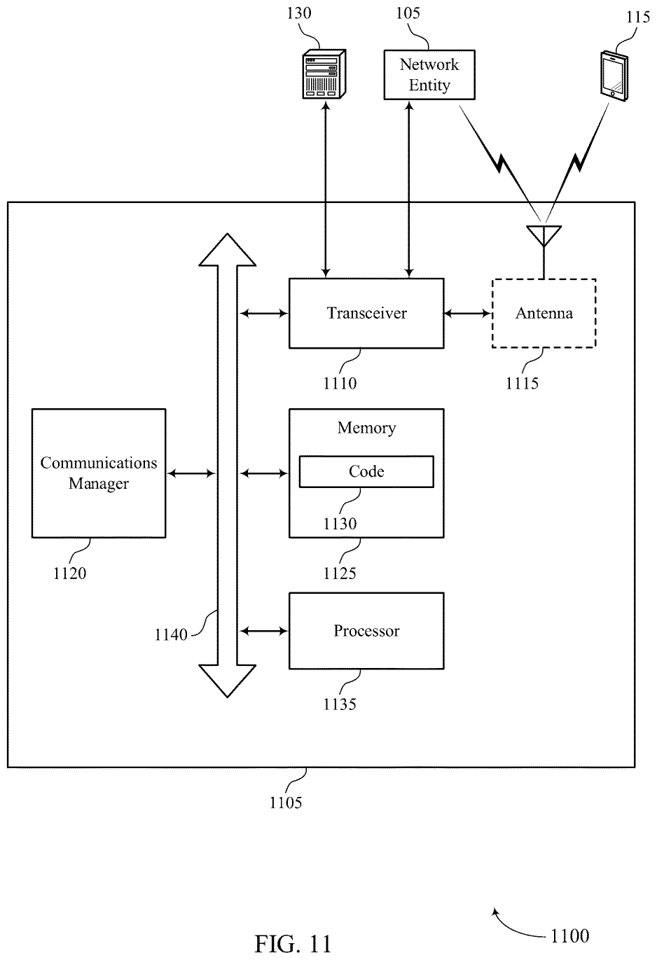

FIG. 11 illustrates a diagram of a system 1100 including a device 1105 that supports block-code based constellation shaping techniques in probabilistic amplitude shaping systems in accordance with one or more aspects of the present disclosure. The device 1105 may be an example of or include the components of a device 705, a device 805, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting block-code based constellation shaping techniques in probabilistic amplitude shaping systems). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 may be configured as or otherwise support a means for generating a set of shaping bits based on a set of multiple information bit sequences, each information bit sequence of the set of multiple information bit sequences including a respective stream of a demultiplexed bit sequence, where the set of shaping bits is based on a quasi-cyclic graphical code. The communications manager 1120 may be configured as or otherwise support a means for applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code. The communications manager 1120 may be configured as or otherwise support a means for transmitting a message including the masked bit sequence.

Additionally, or alternatively, the communications manager 1120 may support wireless communication in accordance with examples as disclosed herein. For example, the communications manager 1120 may be configured as or otherwise support a means for generating at least two sets of shaping bits based on segmenting each of a set of multiple information bit sequences into a set of multiple segments, each information bit sequence of the set of multiple information bit sequences including a respective stream of a demultiplexed bit sequence. The communications manager 1120 may be configured as or otherwise support a means for generating two or more bitmask sequences based on a generator matrix associated with a block code and each set of shaping bits of the at least two sets of shaping bits. The communications manager 1120 may be configured as or otherwise support a means for applying a bitmask sequence to a first information bit sequence of the set of multiple information bit sequences to form a masked bit sequence, where the bitmask sequence includes a concatenation of the two or more bitmask sequences. The communications manager 1120 may be configured as or otherwise support a means for transmitting a message including the masked bit sequence.

Additionally, or alternatively, the communications manager 1120 may support wireless communication in accordance with examples as disclosed herein. For example, the communications manager 1120 may be configured as or otherwise support a means for generating a first set of shaping bits based on a set of multiple information bit sequences, each information bit sequence of the set of multiple information bit sequences including a respective stream of a demultiplexed bit sequence, where the first set of shaping bits is based on a first block code. The communications manager 1120 may be configured as or otherwise support a means for generating a second set of shaping bits based on the set of multiple information bit sequences, where the second set of shaping bits is based on a second block code. The communications manager 1120 may be configured as or otherwise support a means for applying a first bitmask sequence to a first information bit sequence of the set of multiple information bit sequences to form a first masked bit sequence, where the first bitmask sequence is based on the first set of shaping bits and a first generator matrix associated with the first block code. The communications manager 1120 may be configured as or otherwise support a means for applying a second bitmask sequence to a second information bit sequence of the set of multiple information bit sequences to form a second masked bit sequence, where the second bitmask sequence is based on the second set of shaping bits and a second generator matrix associated with the second block code. The communications manager 1120 may be configured as or otherwise support a means for transmitting a message including the first masked bit sequence and the second masked bit sequence.

By including or configuring the communications manager 1120 in accordance with examples as described herein, the device 1105 may support techniques for higher flexibility in bit mapping operations, which may reduce complexity at a receiver resulting in reduced latency and longer battery life.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of block-code based constellation shaping techniques in probabilistic amplitude shaping systems as described herein, or the processor 1135 and the memory 1125 may be otherwise configured to perform or support such operations.

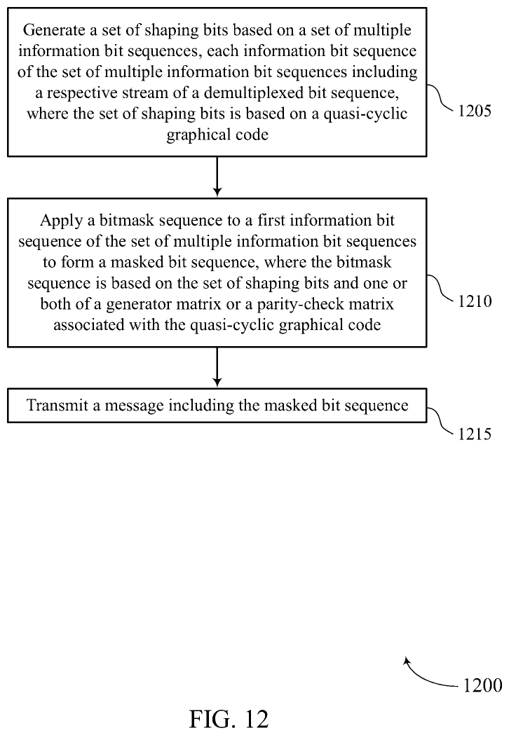

FIG. 12 illustrates a flowchart showing a method 1200 that supports block-code based constellation shaping techniques in probabilistic amplitude shaping systems in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include generating a set of shaping bits based on a set of multiple information bit sequences, each information bit sequence of the set of multiple information bit sequences including a respective stream of a demultiplexed bit sequence, where the set of shaping bits is based on a quasi-cyclic graphical code. The operations of 1205 may be performed in accordance with examples as disclosed herein. In some examples, aspects of the operations of 1205 may be performed by a decoder component 925 as described with reference to FIG. 9.

At 1210, the method may include applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code. The operations of 1210 may be performed in accordance with examples as disclosed herein. In some examples, aspects of the operations of 1210 may be performed by a masking component 930 as described with reference to FIG. 9.

At 1215, the method may include transmitting a message including the masked bit sequence. The operations of 1215 may be performed in accordance with examples as disclosed herein. In some examples, aspects of the operations of 1215 may be performed by a transmission component 935 as described with reference to FIG. 9.

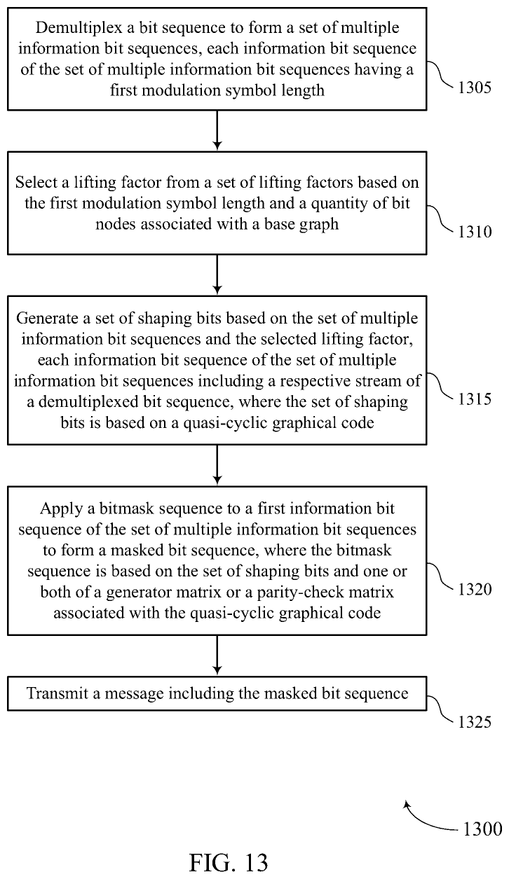

FIG. 13 illustrates a flowchart showing a method 1300 that supports block-code based constellation shaping techniques in probabilistic amplitude shaping systems in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include demultiplexing a bit sequence to form a set of multiple information bit sequences, each information bit sequence of the set of multiple information bit sequences having a first modulation symbol length. The operations of 1305 may be performed in accordance with examples as disclosed herein. In some examples, aspects of the operations of 1305 may be performed by a demultiplexer component 945 as described with reference to FIG. 9.

At 1310, the method may include selecting a lifting factor from a set of lifting factors based on the first modulation symbol length and a quantity of bit nodes associated with a base graph. The operations of 1310 may be performed in accordance with examples as disclosed herein. In some examples, aspects of the operations of 1310 may be performed by a lifting factor component 955 as described with reference to FIG. 9.

At 1315, the method may include generating a set of shaping bits based on the set of multiple information bit sequences and the selected lifting factor, each information bit sequence of the set of multiple information bit sequences including a respective stream of a demultiplexed bit sequence, where the set of shaping bits is based on a quasi-cyclic graphical code. The operations of 1315 may be performed in accordance with examples as disclosed herein. In some examples, aspects of the operations of 1315 may be performed by a decoder component 925 as described with reference to FIG. 9.

At 1320, the method may include applying a bitmask sequence to a first information bit sequence of the set of multiple information bit sequences to form a masked bit sequence, where the bitmask sequence is based on the set of shaping bits and one or both of a generator matrix or a parity-check matrix associated with the quasi-cyclic graphical code. The operations of 1320 may be performed in accordance with examples as disclosed herein. In some examples, aspects of the operations of 1320 may be performed by a masking component 930 as described with reference to FIG. 9.

At 1325, the method may include transmitting a message including the masked bit sequence. The operations of 1325 may be performed in accordance with examples as disclosed herein. In some examples, aspects of the operations of 1325 may be performed by a transmission component 935 as described with reference to FIG. 9.

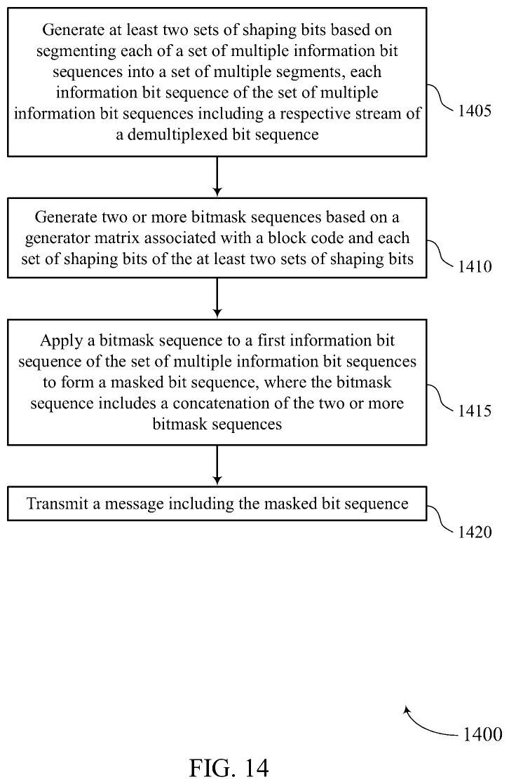

FIG. 14 illustrates a flowchart showing a method 1400 that supports block-code based constellation shaping techniques in probabilistic amplitude shaping systems in accordance with one or more aspects of the present disclosure. The operations of the method 1400 may be implemented by a UE or a network entity or its components as described herein. For example, the operations of the method 1400 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include generating at least two sets of shaping bits based on segmenting each of a set of multiple information bit sequences into a set of multiple segments, each information bit sequence of the set of multiple information bit sequences including a respective stream of a demultiplexed bit sequence. The operations of 1405 may be performed in accordance with examples as disclosed herein. In some examples, aspects of the operations of 1405 may be performed by a decoder component 925 as described with reference to FIG. 9.

At 1410, the method may include generating two or more bitmask sequences based on a generator matrix associated with a block code and each set of shaping bits of the at least two sets of shaping bits. The operations of 1410 may be performed in accordance with examples as disclosed herein. In some examples, aspects of the operations of 1410 may be performed by a masking component 930 as described with reference to FIG. 9.

At 1415, the method may include applying a bitmask sequence to a first information bit sequence of the set of multiple information bit sequences to form a masked bit sequence, where the bitmask sequence includes a concatenation of the two or more bitmask sequences. The operations of 1415 may be performed in accordance with examples as disclosed herein. In some examples, aspects of the operations of 1415 may be performed by a masking component 930 as described with reference to FIG. 9.

At 1420, the method may include transmitting a message including the masked bit sequence. The operations of 1420 may be performed in accordance with examples as disclosed herein. In some examples, aspects of the operations of 1420 may be performed by a transmission component 935 as described with reference to FIG. 9.

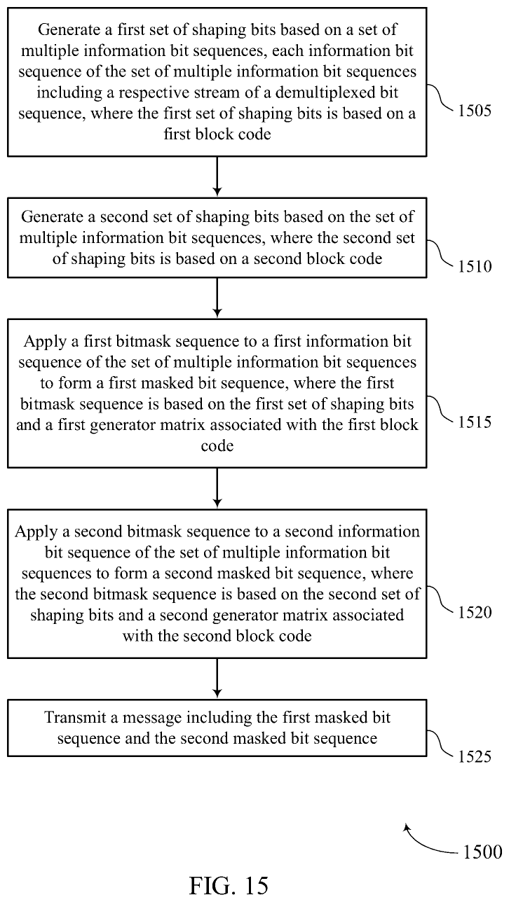

FIG. 15 illustrates a flowchart showing a method 1500 that supports block-code based constellation shaping techniques in probabilistic amplitude shaping systems in accordance with one or more aspects of the present disclosure. The operations of the method 1500 may be implemented by a UE or a network entity or its components as described herein. For example, the operations of the method 1500 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include generating a first set of shaping bits based on a set of multiple information bit sequences, each information bit sequence of the set of multiple information bit sequences including a respective stream of a demultiplexed bit sequence, where the first set of shaping bits is based on a first block code. The operations of 1505 may be performed in accordance with examples as disclosed herein. In some examples, aspects of the operations of 1505 may be performed by a decoder component 925 as described with reference to FIG. 9.

At 1510, the method may include generating a second set of shaping bits based on the set of multiple information bit sequences, where the second set of shaping bits is based on a second block code. The operations of 1510 may be performed in accordance with examples as disclosed herein. In some examples, aspects of the operations of 1510 may be performed by a decoder component 925 as described with reference to FIG. 9.

At 1515, the method may include applying a first bitmask sequence to a first information bit sequence of the set of multiple information bit sequences to form a first masked bit sequence, where the first bitmask sequence is based on the first set of shaping bits and a first generator matrix associated with the first block code. The operations of 1515 may be performed in accordance with examples as disclosed herein. In some examples, aspects of the operations of 1515 may be performed by a masking component 930 as described with reference to FIG. 9.

At 1520, the method may include applying a second bitmask sequence to a second information bit sequence of the set of multiple information bit sequences to form a second masked bit sequence, where the second bitmask sequence is based on the second set of shaping bits and a second generator matrix associated with the second block code. The operations of 1520 may be performed in accordance with examples as disclosed herein. In some examples, aspects of the operations of 1520 may be performed by a masking component 930 as described with reference to FIG. 9.

At 1525, the method may include transmitting a message including the first masked bit sequence and the second masked bit sequence. The operations of 1525 may be performed in accordance with examples as disclosed herein. In some examples, aspects of the operations of 1525 may be performed by a transmission component 935 as described with reference to FIG. 9.

The following provides an overview of aspects of the present disclosure:

Aspect 1: A method for wireless communication, comprising: generating a set of shaping bits based at least in part on a plurality of information bit sequences, each information bit sequence of the plurality of information bit sequences comprising a respective stream of a demultiplexed bit sequence, wherein the set of shaping bits is based at least in part on a quasi-cyclic graphical code; applying a bitmask sequence to a first information bit sequence of the plurality of information bit sequences to form a masked bit sequence, wherein the bitmask sequence is based at least in part on the set of shaping bits and one or both of a generator matrix or a parity-check matrix associated with the quasi-cyclic graphical code; and transmitting a message including the masked bit sequence.

Aspect 2: The method of aspect 1, wherein the quasi-cyclic graphical code is associated with a set of lifting factors for lifting a base graph having a quantity of bit nodes, and generating the set of shaping bits is based at least in part on the set of lifting factors.

Aspect 3: The method of aspect 2, further comprising: demultiplexing the bit sequence to form the plurality of information bit sequences, each information bit sequence of the plurality of information bit sequences having a first modulation symbol length; and selecting a lifting factor from the set of lifting factors based at least in part on the first modulation symbol length and the quantity of bit nodes, wherein generating the set of shaping bits is based at least in part on selecting the lifting factor.

Aspect 4: The method of aspect 3, wherein the lifting factor is selected based at least in part on a product of the lifting factor and the quantity of bit nodes being greater than or equal to the first modulation symbol length.

Aspect 5: The method of any of aspects 3 through 4, further comprising: padding one or more information bit sequences of the plurality of information bit sequences based at least in part on the selected lifting factor and the quantity of bit nodes, wherein generating the set of shaping bits is based at least in part on the padding.

Aspect 6: The method of any of aspects 3 through 5, wherein each lifting factor of the set of lifting factors is associated with a base generator matrix, the method further comprising: selecting the base generator matrix based at least in part on the selected lifting factor, wherein the generator matrix comprises the base generator matrix and generating the set of shaping bits is based at least in part on selecting the base generator matrix.

Aspect 7: The method of any of aspects 3 through 5, wherein each lifting factor of the set of lifting factors is associated with a base parity-check matrix, the method further comprising: selecting the base parity-check matrix based at least in part on the selected lifting factor, wherein the parity-check matrix comprises the base parity-check matrix and generating the set of shaping bits is based at least in part on selecting the base parity-check matrix.

Aspect 8: The method of any of aspects 1 through 7, further comprising: generating the bitmask sequence based at least in part on the set of shaping bits and the generator matrix, wherein applying the bitmask sequence is based at least in part on generating the bitmask sequence.

Aspect 9: The method of any of aspects 1 through 8, wherein the quasi-cyclic graphical code is associated with an iterative decoding process.

Aspect 10: The method of any of aspects 1 through 9, wherein the quasi-cyclic graphical code comprises a quasi-cyclic low-density generator matrix code or a quasi-cyclic low-density parity check code.

Aspect 11: A method for wireless communication, comprising: generating at least two sets of shaping bits based at least in part on segmenting each of a plurality of information bit sequences into a plurality of segments, each information bit sequence of the plurality of information bit sequences comprising a respective stream of a demultiplexed bit sequence; generating two or more bitmask sequences based at least in part on a generator matrix associated with a block code and each set of shaping bits of the at least two sets of shaping bits; applying a bitmask sequence to a first information bit sequence of the plurality of information bit sequences to form a masked bit sequence, wherein the bitmask sequence comprises a concatenation of the two or more bitmask sequences; and transmitting a message including the masked bit sequence.

Aspect 12: The method of aspect 11, further comprising: desegmenting the two or more bitmask sequences to form the concatenation of the two or more bitmask sequences, wherein applying the bitmask sequence is based at least in part on desegmenting the two or more bitmask sequences.

Aspect 13: The method of any of aspects 11 through 12, further comprising: demultiplexing the bit sequence to form the plurality of information bit sequences, each information bit sequence of the plurality of information bit sequences having a first modulation symbol length, wherein the block code is associated with a first block size, the first block size being less than the first modulation symbol length; and segmenting each of the plurality of information bit sequences into the plurality of segments, a quantity of the plurality of segments being based at least in part on the first modulation symbol length and the first block size, and wherein generating the at least two sets of shaping bits is based at least in part on the segmenting.

Aspect 14: The method of aspect 13, further comprising: padding one or more segments of the plurality of segments such that the quantity of the plurality of segments comprises an integer value.

Aspect 15: The method of any of aspects 13 through 14, further comprising: puncturing one or more segments of the plurality of segments such that the quantity of the plurality of segments comprises an integer value.

Aspect 16: The method of any of aspects 11 through 15, further comprising: decoding each segment of the plurality of segments using the block code.

Aspect 17: The method of any of aspects 11 through 16, wherein the at least two sets of shaping bits are generated in parallel.

Aspect 18: A method for wireless communication, comprising: generating a first set of shaping bits based at least in part on a plurality of information bit sequences, each information bit sequence of the plurality of information bit sequences comprising a respective stream of a demultiplexed bit sequence, wherein the first set of shaping bits is based at least in part on a first block code; generating a second set of shaping bits based at least in part on the plurality of information bit sequences, wherein the second set of shaping bits is based at least in part on a second block code; applying a first bitmask sequence to a first information bit sequence of the plurality of information bit sequences to form a first masked bit sequence, wherein the first bitmask sequence is based at least in part on the first set of shaping bits and a first generator matrix associated with the first block code; applying a second bitmask sequence to a second information bit sequence of the plurality of information bit sequences to form a second masked bit sequence, wherein the second bitmask sequence is based at least in part on the second set of shaping bits and a second generator matrix associated with the second block code; and transmitting a message including the first masked bit sequence and the second masked bit sequence.

Aspect 19: The method of aspect 18, further comprising: selecting the first block code for generating the first set of shaping bits based at least in part on the first information bit sequence being associated with a higher transmit power than the second information bit sequence, wherein generating the first set of shaping bits is based at least in part on selecting the first block code.

Aspect 20: The method of any of aspects 18 through 19, further comprising: selecting the second block code for generating the second set of shaping bits based at least in part on the second information bit sequence being associated with a lower transmit power than the first information bit sequence, wherein generating the second set of shaping bits is based at least in part on selecting the second block code.

Aspect 21: The method of any of aspects 18 through 20, wherein the first block code and the second block code comprise block codes having different code lengths, different coding rates, or both.

Aspect 22: The method of aspect 21, wherein further comprising: generating the first set of shaping bits and the second set of shaping bits based at least in part on segmenting each of the plurality of information bit sequences into a plurality of segments, wherein segmenting each of the plurality of information bit sequences is based at least in part on the first block code and the second block code comprising the block codes having the different code lengths.

Aspect 23: The method of any of aspects 18 through 22, wherein the first block code and the second block code comprise a same block code.

Aspect 24: The method of any of aspects 18 through 23, wherein the first information bit sequence comprises a sequence of most significant bits associated with the message, and the second information bit sequence comprises a sequence of second most significant bits associated with the message.

Aspect 25: The method of any of aspects 18 through 24, wherein the first set of shaping bits and the second set of shaping bits are generated in parallel.

Aspect 26: The method of any of aspects 18 through 22, 24, and 25, wherein the first block code comprises a first code, and the second block code comprises a second code different from the first code.

Aspect 27: The method of aspect 26, wherein the first code comprises a polar code, and the second code comprises a Hamming code.

Aspect 28: An apparatus for wireless communication, comprising a processor; memory coupled with the processor; and instructions stored in the memory and executable by the processor to cause the apparatus to perform a method of any of aspects 1 through 10.

Aspect 29: An apparatus for wireless communication, comprising at least one means for performing a method of any of aspects 1 through 10.

Aspect 30: A non-transitory computer-readable medium storing code for wireless communication, the code comprising instructions executable by a processor to perform a method of any of aspects 1 through 10.

Aspect 31: An apparatus for wireless communication, comprising a processor; memory coupled with the processor; and instructions stored in the memory and executable by the processor to cause the apparatus to perform a method of any of aspects 11 through 17.

Aspect 32: An apparatus for wireless communication, comprising at least one means for performing a method of any of aspects 11 through 17.

Aspect 33: A non-transitory computer-readable medium storing code for wireless communication, the code comprising instructions executable by a processor to perform a method of any of aspects 11 through 17.

Aspect 34: An apparatus for wireless communication, comprising a processor; memory coupled with the processor; and instructions stored in the memory and executable by the processor to cause the apparatus to perform a method of any of aspects 18 through 27.

Aspect 35: An apparatus for wireless communication, comprising at least one means for performing a method of any of aspects 18 through 27.

Aspect 36: A non-transitory computer-readable medium storing code for wireless communication, the code comprising instructions executable by a processor to perform a method of any of aspects 18 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
a processor;
memory in electronic communication with the processor; and
instructions stored in the memory, wherein the instructions are executable by the processor to:
generate a set of shaping bits based at least in part on a plurality of information bit sequences, each information bit sequence of the plurality of information bit sequences comprising a respective stream of a demultiplexed bit sequence, wherein the set of shaping bits is based at least in part on a quasi-cyclic graphical code;
apply a bitmask sequence to a first information bit sequence of the plurality of information bit sequences to form a masked bit sequence, wherein the bitmask sequence is based at least in part on the set of shaping bits and one or both of a generator matrix or a parity-check matrix associated with the quasi-cyclic graphical code; and
transmit a message including the masked bit sequence.

2. The apparatus of claim 1, wherein the quasi-cyclic graphical code is associated with a set of lifting factors for lifting a base graph having a quantity of bit nodes and generating the set of shaping bits is based at least in part on the set of lifting factors.

3. The apparatus of claim 2, wherein the instructions are further executable by the processor to cause the apparatus to:
demultiplex the bit sequence to form the plurality of information bit sequences, each information bit sequence of the plurality of information bit sequences having a first modulation symbol length; and
select a lifting factor from the set of lifting factors based at least in part on the first modulation symbol length and the quantity of bit nodes, wherein generating the set of shaping bits is based at least in part on selecting the lifting factor.

4. The apparatus of claim 3, wherein the lifting factor is selected based at least in part on a product of the lifting factor and the quantity of bit nodes being greater than or equal to the first modulation symbol length.

5. The apparatus of claim 3, wherein the instructions are further executable by the processor to cause the apparatus to:
pad one or more information bit sequences of the plurality of information bit sequences based at least in part on the selected lifting factor and the quantity of bit nodes, wherein generating the set of shaping bits is based at least in part on the padding.

6. The apparatus of claim 3, wherein each lifting factor of the set of lifting factors is associated with a base generator matrix, and the instructions are further executable by the processor to cause the apparatus to:
select the base generator matrix based at least in part on the selected lifting factor, wherein the generator matrix comprises the base generator matrix and generating the set of shaping bits is based at least in part on selecting the base generator matrix.

7. The apparatus of claim 3, wherein each lifting factor of the set of lifting factors is associated with a base parity-check matrix, and the instructions are further executable by the processor to cause the apparatus to:
select the base parity-check matrix based at least in part on the selected lifting factor, wherein the parity-check matrix comprises the base parity-check matrix and generating the set of shaping bits is based at least in part on selecting the base parity-check matrix.

8. The apparatus of claim 1, wherein the instructions are further executable by the processor to cause the apparatus to:
generate the bitmask sequence based at least in part on the set of shaping bits and the generator matrix, wherein applying the bitmask sequence is based at least in part on generating the bitmask sequence.

9-10. (canceled)

11. An apparatus for wireless communication, comprising:
a processor, memory in electronic communication with the processor, and instructions stored in the memory, wherein the instructions are executable by the processor to:
generate at least two sets of shaping bits based at least in part on segmenting each of a plurality of information bit sequences into a plurality of segments, each information bit sequence of the plurality of information bit sequences comprising a respective stream of a demultiplexed bit sequence;
generate two or more bitmask sequences based at least in part on a generator matrix associated with a block code and each set of shaping bits of the at least two sets of shaping bits;
apply a bitmask sequence to a first information bit sequence of the plurality of information bit sequences to form a masked bit sequence, wherein the bitmask sequence comprises a concatenation of the two or more bitmask sequences; and
transmit a message including the masked bit sequence.

12. The apparatus of claim 11, wherein the instructions are further executable by the processor to cause the apparatus to:
desegment the two or more bitmask sequences to form the concatenation of the two or more bitmask sequences, wherein applying the bitmask sequence is based at least in part on desegmenting the two or more bitmask sequences.

13. The apparatus of claim 11, wherein the instructions are further executable by the processor to cause the apparatus to:
demultiplex the bit sequence to form the plurality of information bit sequences, each information bit sequence of the plurality of information bit sequences having a first modulation symbol length, wherein the block code is associated with afirst block size, the first block size being less than the first modulation symbol length; and
segment each of the plurality of information bit sequences into the plurality of segments, a quantity of the plurality of segments being based at least in part on the first modulation symbol length and the first block size, and wherein generating the at least two sets of shaping bits is based at least in part on the segmenting.

14-15. (canceled)

16. The apparatus of claim 11, wherein the instructions are further executable by the processor to cause the apparatus to:
decode each segment of the plurality of segments using the block code.

17. The apparatus of claim 11, wherein:
the at least two sets of shaping bits are generated in parallel.

18. An apparatus for wireless communication, comprising:
a processor;
memory in electronic communication with the processor; and
instructions stored in the memory, wherein the instructions are executable by the processor to:
generate a first set of shaping bits based at least in part on a plurality of information bit sequences, each information bit sequence of the plurality of information bit sequences comprising a respective stream of a demultiplexed bit sequence, wherein the first set of shaping bits is based at least in part on a first block code;
generate a second set of shaping bits based at least in part on the plurality of information bit sequences, wherein the second set of shaping bits is based at least in part on a second block code;
apply a first bitmask sequence to a first information bit sequence of the plurality of information bit sequences to form a first masked bit sequence, wherein the first bitmask sequence is based at least in part on the first set of shaping bits and a first generator matrix associated with the first block code;
apply a second bitmask sequence to a second information bit sequence of the plurality of information bit sequences to form a second masked bit sequence, wherein the second bitmask sequence is based at least in part on the second set of shaping bits and a second generator matrix associated with the second block code; and
transmit a message including the first masked bit sequence and the second masked bit sequence.

19. The apparatus of claim 18, wherein the instructions are further executable by the processor to cause the apparatus to:
select the first block code for generating the first set of shaping bits based at least in part on the first information bit sequence being associated with a higher transmit power than the second information bit sequence, wherein generating the first set of shaping bits is based at least in part on selecting the first block code.

20. The apparatus of claim 18, wherein the instructions are further executable by the processor to cause the apparatus to:
select the second block code for generating the second set of shaping bits based at least in part on the second information bit sequence being associated with a lower transmit power than the first information bit sequence, wherein generating the second set of shaping bits is based at least in part on selecting the second block code.

21. The apparatus of claim 18, wherein the first block code and the second block code comprise block codes having different code lengths, different coding rates, or both.

22. (canceled)

23. The apparatus of claim 18, wherein the first block code and the second block code comprise a same block code.

24. The apparatus of claim 18, wherein the first information bit sequence comprises a sequence of most significant bits associated with the message, and the second information bit sequence comprises a sequence of second most significant bits associated with the message.

25. (canceled)

26. The apparatus of claim 18, wherein the first block code comprises a first code, and the second block code comprises a second code different from the first code.

27-30. (canceled)
